(19) United States
(12) Patent Application Publication
(10) Pub. No.: US 2014/0035698 A1
(43) Pub. Date: Feb. 6, 2014

(54) Microstrip-Fed Crossed Dipole Antenna Having Remote Electrical Tilt

(71) Applicant: Dielectric, LLC, Raymond, ME (US)

(72) Inventors: John L. Schadler, Raymond, ME (US); Mohammad Adeel, Raymond, ME (US); Mike Davison, Raymond, ME (US)

(21) Appl. No.: 13/958,883

(22) Filed: Aug. 5, 2013

Related U.S. Application Data
(60) Provisional application No. 61/679,589, filed on Aug. 3, 2012.

(51) Int. Cl. H01P 5/12; H01P 1/18

(52) U.S. Cl. CPC H01P 1/184
USPC 333/128; 333/161

(57) ABSTRACT

A panel antenna includes a microstrip-fed radiator array, each radiator being a crossed dipole, with the monopoles of the dipole being loops that are electrically closed and hybrid coupled to the adjacent loops within the radiator. The loops are spaced away from a ground plane. Each four loops and four support straps and a base can be cast as a single piece, for example, since the shorted ends of the support straps are a quarter wavelength away from the loops. The feed system uses asymmetric microstrip power dividers to provide branch feed to the dipoles. Coupling between the feed and the loops uses the support straps and terminates in a stub at the characteristic impedance. Each feed terminates so as to provide roughly a half wavelength of delay for the second monopole, making a differentially-driven dipole. The internal feed permits remote adjustment of phase.

### CROSS-REFERENCE TO RELATED APPLICATIONS

This application claims the benefit from U.S. Provisional Application No. 61/679,589 filed on Aug. 3, 2012, which is hereby incorporated by reference in its entirety for all purposes as if fully set forth herein. This application is related to U.S. Provisional Application No. 61/679,535 filed on Aug. 3, 2012, which is hereby incorporated by reference in its entirety for all purposes as if fully set forth herein.

### FIELD OF THE INVENTION

The present invention relates generally to radio-frequency (RF) electromagnetic signal communication antennas. More particularly, the present invention relates to directional antenna radiators and associated signal distribution apparatus for low- to medium-power transmitting and transceiver functions, wherein the signal distribution apparatus is configurable to support remote electrical tilt (RET) functionality.

### BACKGROUND OF THE INVENTION

A number of concepts are not present in the prior art and may enhance performance, increase reliability, lower material and/or labor costs, etc., each of which can be beneficial, particularly in high-volume and cost-sensitive applications.

As taught in the above-noted related application, by the same inventive entity, and having the same assignee, a radiator array can be fed entirely by a (coaxial input) microstrip feed system, to considerable advantage in signal attenuation and simplicity of construction, and potentially lower distortion due to passive intermodulation (PIM). Such a concept typically has significant benefits, but does not address an additional issue well known in the broadcast and transceiver antenna marketplace, namely a need for variable signal propagation range, either by one-time adjustment or in response to real-time requirements, changes, and the like.

Panel antenna beam characteristics such as dip angle (i.e., beam elevation that differs from the beam's being perpendicular to an integral ground plane of the panel) and beam directivity (largely gain-related) typically have nominal values based on antenna design. Several existing technologies allow beam elevation from an antenna such as a tower-mounted cellular telephone radiator array to be adjusted, so that the beam target, and hence the number of user telephones in office buildings or on commuting roads, for example, can be repeatedly adapted, such as over the course of a day. In one such technology, the entire panel is tipped downward or upward by a few degrees using a motorized apparatus that shortens or extends a mounting fitting at the panel's top or bottom, with a pivot at the opposite extent, for example. Arrangements that have no visibly moving parts may have significant advantages over such devices. Prior art arrangements without external moving parts may have other drawbacks, however, so the art remains in need of a technology having performance that differs from that of existing practice.

### SUMMARY OF THE INVENTION

The foregoing needs are met, to a great extent, by the invention, wherein in one aspect an apparatus is provided that in some embodiments is a multi-radiator panel antenna that has at least one row of discrete dual-feed crossed-dipole hybrid-coupled radiators fed by a plurality of microstrip-based power dividers, with the microstrip technology extending continuously from at least one coaxial input connector to a plurality of terminations that couple to the individual radiators. The same core design may be adapted to be used for transmitting, receiving, and combined (transceiver) applications in a variety of frequency regimes, with dimensions, materials, manufacturing processes, coatings, etc., modified as required for use in each such application.

In accordance with one embodiment of the present invention, a radio-frequency signal power divider having variable phase is disclosed. The power divider includes an enclosure, a first microstrip segment that joins a feed connector at an attachment point, the longest dimension and the width dimension of the first segment being parallel to and proximal to a first one of the inner surfaces of the enclosure, and an internal chamber formed within the first microstrip segment, open at an end distal to the feed connector, the open end including an edge proximal to the first enclosure inner surface.

The power divider further includes a second microstrip segment inserted in part into the internal chamber, with a surface of the second microstrip segment proximal to the enclosure first inner surface being in electrical contact with the edge, the second microstrip segment having an axis of insertion, to which axis slideable motion of the second segment over a range is constrained, conduction between the second microstrip segment and the edge being maintained. The power divider further includes a third microstrip segment, whereof a middle region is so configured with respect to the second segment terminal face as to form a slideable tee junction having such width that the second-segment terminal impedance equals the parallel combination of the third-segment impedances proximal to the tee, the third microstrip segment further being configured with two terminal ends. The power divider further includes two load segments, each having a middle region configured to form a slideable tee junction with a third microstrip segment terminal end.

In accordance with another embodiment of the invention, a method for varying the phase of an electromagnetic input signal applied to a plurality of radiators is disclosed. The method includes configuring a power divider with corporate feed in the form of a plurality of successive branchings of a signal path from an input port, configuring at least one intermediate branching element of the power divider with a slideable input locus intermediate along a longitudinal extent thereof, and a slideable output locus at each of two distal ends thereof, and configuring an extensible element of the power divider with a fixed first segment and with a second segment that is conductively in contact with the first segment and occupies at least in part a void within the first segment. The method further includes establishing substantially constant impedance over a region proximal to a terminus of the first segment and providing a slideable coupling between a distal end of the second segment of the extensible element and the input locus of the intermediate branching element.

There have thus been outlined, rather broadly, certain embodiments of the invention in order that the detailed description thereof herein may be better understood, and in order that the present contribution to the art may be better appreciated. There are, of course, additional embodiments of the invention which will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE FIGURES

FIG. 1 is a perspective view illustrating an antenna panel assembly having a radiator array and a feed system, in accordance with the invention.

FIG. 2 is a sectional view through an antenna panel in accordance with the invention.

FIG. 3 is a perspective view showing a radiator and feed parts of an antenna panel in accordance with FIG. 1.

FIG. 4 shows an antenna panel with a sliding interface between components for dynamic adjustment of the phase relationships between radiators, in accordance with an aspect of the instant invention.

FIG. 5 is a view of a slide mechanism for FIG. 4.

FIG. 6 is a schematic diagram of phasing for a feed system in accordance with an aspect of the invention.

FIG. 7 shows an additional view of a gearing mechanism in accordance with an aspect of the invention.

FIG. 8 shows a partial illustration of an antenna panel with a coaxial interface between components in accordance with another aspect of the instant invention.

### DETAILED DESCRIPTION

The invention will now be described with reference to the drawing figures, in which like reference numerals refer to like parts throughout. An embodiment in accordance with the present invention provides a multiple-radiator antenna that realizes beam forming according to a selected performance standard, and that provides signal distribution within the antenna using air-dielectric microstrip technology largely to the exclusion of other transmission line technologies. In some embodiments, such an antenna can combine exceptionally low losses with inexpensive components, ease of manufacture, and desirable levels of reliability over a useful range of ordinary climate environments.

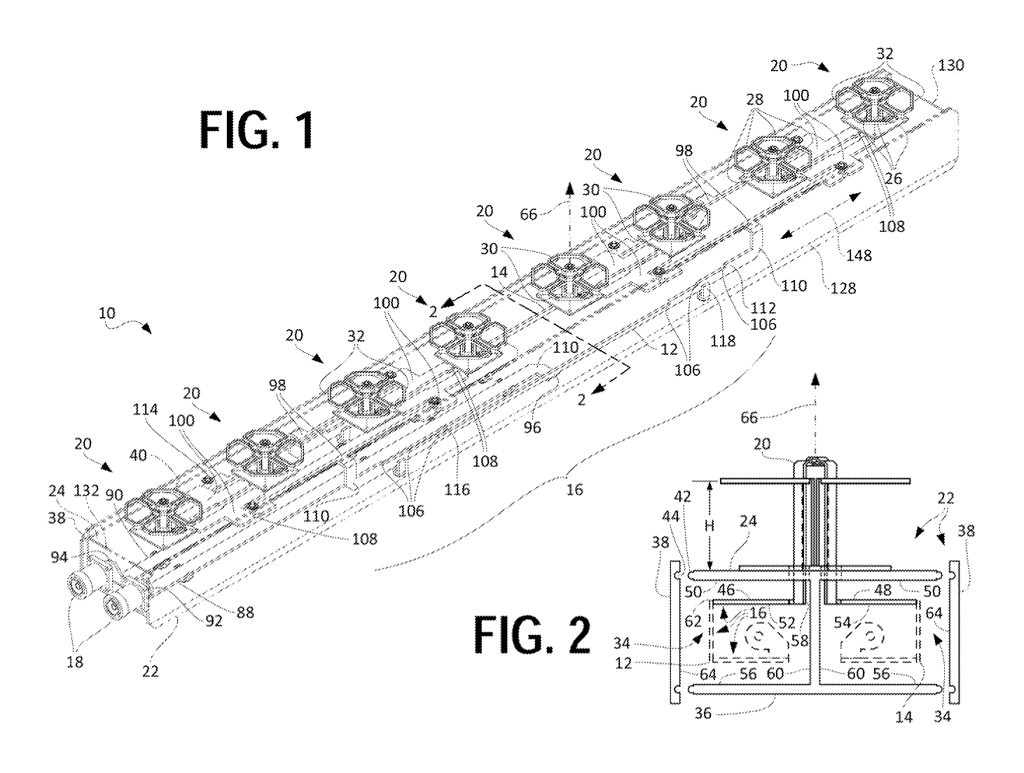

FIG. 1 is a perspective view showing an antenna panel 10 that represents an advancement with reference to a series of crossed dipole designs. The antenna of FIG. 1 uses microstrips 12, 14 in a corporate feed signal distribution structure 16 that may in some embodiments originate from an end locus as shown (mid-panel feed and other arrangements may be used), using one or more feed connectors 18, that may be presented as coaxial. The distribution structure 16 may route to each of a plurality of crossed-dipole loop radiators 20. The microstrip 12, 14 arrangement can beneficially lower some manufacturing and material costs compared to coaxial and even stripline structures, for example, and, by preferential recourse to air dielectric, can combine low passive intermodulation (PIM) with strikingly low attenuation compared to designs that rely on solid or foamed polymer, ceramic, and other classes of dielectric material. The microstrip 12, 14 feed is discussed in greater detail below.

A conductive enclosure 22 can be a unitary metallic extrusion, for example, with the outer face on which the radiators 20 are mounted functioning as a ground plane 24 for the array of radiators 20. If the radiators 20 are configured with integral conducting mounting structures 26, also discussed in greater detail below, the loop elements 28 of the radiators 20 can be economically spaced at roughly one quarter wavelength (H, FIG. 2) above the ground plane 24 with high reproducibility. This allows a direct signal portion radiated away from the ground plane 24 from the loop elements 28 to be reinforced by a reflected signal, originally the signal portion directed toward the ground plane 24, reflected back to the plane of the dipoles 30, 32 after a half-wavelength and half-cycle of travel. The time delay due to this propagation and the phase reversal due to reflection place the reflected signal in phase with the direct portion of the signal emitted a half-cycle later. The loop elements 28 are preferentially configured as crossed dipole pairs 30, 32.

FIG. 2, is a section view of an embodiment similar to that of FIG. 1, and shows a representative internal structure for such an embodiment, including an extrusion configuration that may provide two separate chambers 34 in support of a single row of radiators 20. Where the enclosure 22 is built up from one or more pieces of material that may be extruded to have a combined profile selected for the purpose, as shown, the enclosure 22 can function as a robust mechanical structure, while one or more conductive-walled chambers 34 can be provided behind a radiator-side surface ground plane 24. The chambers 34 can allow the distribution structure 16 to achieve notable signal transmission efficacy and power division accuracy. As discussed further below, the microstrips 12, 14 may be each spaced unequally from the various walls of the chambers 34. This placement may cause the microstrips 12, 14 to exhibit a nearly nominal microstrip behavior, whereas equal spacing may cause microstrip 12, 14 operation to more closely approximate that of a conventional stripline as taught in the art.

The conductive enclosure 22 style shown in FIG. 2 may have an H-section main extrusion 36 and may include two closing walls 38. In the variation shown in FIG. 1, the main extrusion 36 may have flanges 40 instead of the beads 42 and retention slots 44 of FIG. 2. Each of the flange 40 and bead-and-slot configurations, along with others, has some advantages. The flange 40 arrangement may permit using a single H-section extrusion 36 and a single flat sheet metal closing wall 38 design that may accommodate at least single-row and dual-row panels, for example, while the bead-and-slot design may reduce fastenings. Other arrangements may include a single continuous extrusion into which the microstrips 12, 14 must be inserted from an end. At least some styles of flange 40 (FIG. 1) or corresponding extension of the closing wall 38 on the radiator 20 side may cause the combined surface to act as a cavity reflector, increasing gain. These and other styles may permit additional flanges, distal to the radiators 20, to be adapted for use in mounting a panel 10.

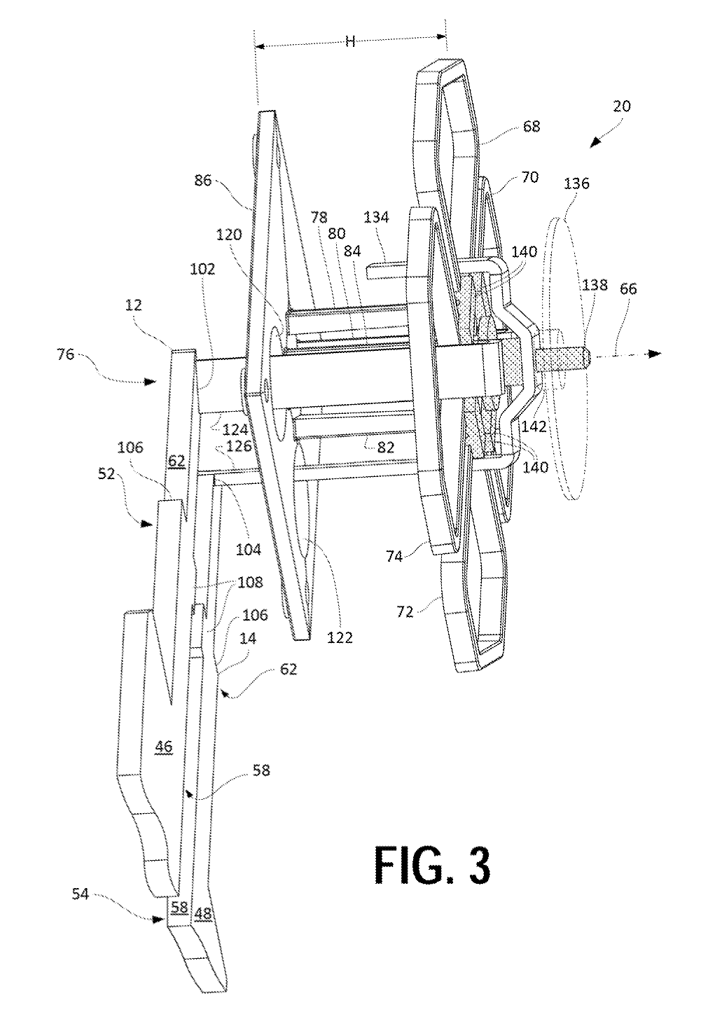

FIG. 3 is a second perspective view, showing one representative radiator 20 and representative terminal nodes of two microstrip signal conductors 12, 14 as arranged within both conductive chambers 34 of the conductive enclosure 22 of FIG. 2. Positioning of the microstrips 12, 14 within the enclosure 22 may be based on the concepts developed in U.S. patent application Ser. No. 13/276,516 ('516), so that the first faces 46, 48 of the microstrips 12, 14 may be positioned close to first (extruded, interior) conductive walls 50 of the chambers 34, while second faces 52, 54 of the microstrips 12, 14 may be much more distant from the second conductive faces 56 of the chambers 34. First edges 58 of the microstrips 12, 14 may have substantially uniform spacing from third walls 60 of the chambers 34, consistent with the concept disclosed in the above-referenced '516. Second edges 62 of the microstrips 12, 14 may have stepwise variable spacing from the fourth interior walls 64 of the chambers 34, with the widths of the microstrips 12, 14 between the uniform-spaced edges 58 and the variable-spaced edges 62 such that they may define a sequence of steps in impedance that allow power level, phasing, and impedance at each radiator 20 to be set at a specific value. It is to be understood that the wall identification above may be different after each bend in the microstrips 12, 14, as best seen in FIG. 1. Faces 46 and 52 and edges 58 and 62, for example, are shown using solid lines and are labeled in FIGS. 2 and 3 for the section of the microstrips 12, 14 that terminates at the radiator 20 inputs. Faces and edges are shown dashed and unlabeled in FIG. 2 beyond the bends of the microstrips 12, 14. FIG. 1 shows that, beginning at the input connectors 18, first the interior faces 56 distal to the radiators 20, then the interior faces 64 distal to one another, and finally the interior faces 50 proximal to the radiators 20 may serve in turn as the proximal walls to the first faces 46, 48 of the microstrips 12, 14.

Spacing from each face or edge of a microstrip to the proximal chamber wall according to the disclosure may be consistently less than spacing suggested by traditional stripline and microstrip analysis. These smaller and in some cases possibly irregular distances make classical pencil-and-paper analysis non-obvious, but where ray tracing can be applied to modeling using robust software and relatively fast computers, a revised and simplified set of rules allows initial estimates to be refined quickly with modest dimensional adjustments. These rules include the following.

Provide an application that allows an enclosure in the form of a structure achievable by a single extrusion, a set of interlocking extrusions, a welded equivalent, or the like. A plausible material may be any of a range of extrusion-compatible aluminum alloys, although a stiffer, rolled alloy or another metal may be used in some applications. Some uses of the invention may call for yet other materials.

Employ microstrip conductors, likewise that may be made from metal, such as rolled, cut, and formed aluminum alloy, or another material. The conductors may be held in place within the enclosure by spacers that cooperate with microstrip stiffness to make the electrical structure largely dimensionally invariant except for temperature-induced expansion, caused by environmental factors, power dissipation, etc. Performance analysis by simulation may be made more rigorous by including a wide range of temperatures for each component compared to the others.

Fabricate the radiators from aluminum-clad cast zinc alloy, punched and folded aluminum alloy, or another material and use a fabrication process capable of similar performance. Raw zinc alloy has relatively high skin-effect penetration at the likely frequencies for antennas of the designs considered here, so that a nickel preparative coating and aluminum plating may beneficially decrease losses and may provide more uniform operation. Other construction concepts may likewise balance high performance, reliability, and low cost similarly to those indicated.

The inventive concepts presented herein relate to electronic systems over a broad range of frequencies, but application to microwave and near-microwave art (traditionally with a free-space wavelength shorter than 1 meter, corresponding to frequencies higher than 300 MHz) are of particular interest. Frequencies of interest for typical applications may include at least cellular telephone bands, such as the GSM 900 MHz band and the 1710 MHz-2170 MHz band, as well as the reclaimed high-UHF television frequencies around 700 MHz-800 MHz, the low cellular bands around 450 MHz, satellite communications bands, etc. Other frequencies are contemplated as well. The concept as taught herein may be scalable over a wide range, so that significantly higher and lower frequencies than these may likewise be considered, with radiator and backplane adjusted in size to realize comparable performance levels. It is to be understood that lower frequencies do not bar use of the concepts except insofar as manufacturing costs for the very large components needed for lower frequencies may be greater, and that limitations at higher frequencies relate to dimensions of components with respect to voltage withstand at power levels high enough to be useful. At frequencies significantly higher than present cellular telephone ranges, the use of circuit-board methods and materials in building numerically large two-dimensional arrays of low-power components may be beneficial. While miniaturization of low-loss air-dielectric antennas may be more difficult, it is anticipated that there is considerable overlap between the various antenna arts.

In some non-RET embodiments, a user may elect to engineer a particular embodiment so that all power levels, signal phase values, and impedances to be found at the respective radiators are substantially equal to one another. Assuming nominal (i.e., symmetrical, matched to theory, etc.) radiators 20, this can provide a beam perpendicular to the ground plane 24, with each radiator 20 emitting a so-called skull pattern, and with emission patterns, as detected at far field, effectively overlaid. Net antenna gain at each azimuth in such embodiments can be predicted by multiplying the (voltage) gain of a single radiator by the number of radiators. To the extent that the radiators 20 themselves are not nominal, a beam so formed, while still an overlay of its constituents, may exhibit so-called “squint,” i.e., each radiator's emission pattern may fail to be concentric with the respective radiator's axis of rotational symmetry 66. Beam overlay may likewise be non-ideal, typically resulting in a reduction of far-field gain. Although squint is not further addressed in the disclosure, existence of this and other propagation artifacts may be anticipated, modeled, tested, and compensated for in practice to the extent necessary for an embodiment.

At least in non-orthogonal, non-RET embodiments, phasing and impedance may have fixed values, and power levels may be made unequal according to a plan that causes the beam to be non-uniform in elevation and directed (tilted) below the horizon toward which the axis 66 is directed (this applies to terrestrial broadcasting; for aircraft communication and applications that call for different patterns, other power distribution plans may be developed using similar approaches). Similarly, assigning different phasing to each radiator 20 according to some plans may result in a tilt comparable to that of a varied-power embodiment. For either of these, beam shape may be symmetric about a nominal elevation angle to a greater or lesser extent. Altering the third variable above, i.e., assigning different impedances to different power distribution output ports, may also be feasible, although it may require a corresponding (non-uniform) input port impedance to each radiator 20 to limit return losses. In addition to the above realizations of beam direction, an entire non-RET panel array 10 can be tilted to direct a uniform (perpendicular to the ground plane 24) beam. These methods may be combined, although not all may interoperate equally well in shaping gain (transmitted signal strength, received signal sensitivity) over an area.

Continuing with FIG. 3, the crossed dipole radiator 20 of the invention may be differentiated at least in its feed design and in being practical for fabrication as a single unit, which fabrication process may be, for example, casting, forging, sintering, or pressing, formation by steps of punching and folding of sheet metal, etc. Each of the four loops 68, 70, 72, 74 may be a monopole that may be supported at the loops' common proximal locus 76 by a respective conductive flat tab 78, 80, 82, 84 that may be roughly a quarter wavelength (dimension H) long, so that the integral base 86 and the ground plane 24 (FIGS. 1 and 2) to which the base 86 attaches may appear electrically as an open circuit to the loops 68, 70, 72, 74. Each of the flat tabs 78, 80, 82, 84 may function as one component of a microstrip, and, as in other microstrip designs, may be understood to act as one of two facing walls of a segment of waveguide having open sidewalls.

As shown in FIG. 1, the signal distribution strategy for the two inputs to each radiator 20 may use two separate input feeds 88, 90 from input attachment points 92, 94 of the two microstrips 12, 14. Each microstrip 12, 14 may have been split as needed using tee junctions 96, 98, 100 (also termed tee split points herein), to apply a portion of its signal energy to each radiator 20. Returning to FIG. 3, each microstrip 12, 14, after successive divisions, may drive one of the two inputs 102, 104 of each radiator 20. For all microstrip segments, distances between tee split points 96, 98, 100 may be selected to determine propagation timing, while step changes 106 in widths of the segments and lump impedance elements 108 may define impedances before and after the respective splits, and thus may contribute to defining power division at each split. Note that a wall 60 (FIG. 2, not shown in FIG. 3) may isolate the microstrips 12, 14. Impedance-change steps 106 and lumps 108 may affect signal phase, so step size and placement may also be factors controlling relative timing of the respective radiator 20 output signals. Likewise, each change 106, 108 in dimensions can alter transfer function characteristics of the microstrips 12, 14. This may preferentially make each signal path branch or step substantially identical to the others in order to minimize differences in signal content of the energy applied to each (effectively identical) radiator 20. Thus, dimensions of the microstrips 12, 14 at least in non-RET embodiments may likely be factors affecting properties such as beam tilt.

The embodiment shown in FIGS. 1-3 may use corporate (also termed branch) feed, with the input signal possibly being split repeatedly and each radiator 20 and preferably receiving a portion of the signal energy on the same cycle of the waveform, within a phase range that may be determined by spacing of splits, size of impedance steps, etc. In some embodiments, other feed methods may be used, such as traveling wave (TW) feed, wherein a single pair of feed lines (in a dual-input embodiment) may traverse all radiators in succession, with a portion of the signal energy in the feed lines coupled to the dipoles of each radiator. With judiciously selected dimensions for power coupling and signal phasing, TW couplers can tap off substantially all of the input power before reaching a terminal load, and the timing and strength of each output can be set according to a selected scheme. It is to be understood that in the particular case of TW feed, each successive radiator may receive its input one cycle later than the radiator next closer to the source, a phenomenon that may have negligible deleterious effect for many applications, whereas typical branch feed applications may drive all radiators in synchronism, aside from phase adjustments. Extending this concept, half-wave, double-wave, and other spacings of radiators and feed lines can produce comparable results if considerations peculiar to each such spacing, such as grating lobes, are accommodated.

Branch and TW feed lines may be readily analyzed and simulated using commercial stripline and microstrip analysis software. The same analysis and simulation software can include flat tabs 78, 80, 82, 84 and input feeds 102, 104 found in terminal portions of circuits used in embodiments of the invention. Regarding a related-art non-RET microstrip branch feed power divider 12, each tee divider 96, 98, 100 may be placed asymmetrically in a chamber 34 that may be effectively grounded on all walls 50, 56, 60, 64. That is, a first face 46 of the microstrip 12 may be positioned proximal to a first wall 50 of the chamber 34 at a roughly uniform first face distance, a first edge 58 of the microstrip 12 may be continuous and may be positioned at a roughly continuous first edge distance from a second chamber wall 60, a second face 52 of the microstrip 12 may be positioned at a roughly uniform second face distance from a third chamber wall 56, and the second edge 62 of the microstrip 12 may be stepped as required for impedance transformation and consequently may be positioned with nonuniform spacing with respect to the fourth chamber wall 64. The microstrip 12 may not be spaced five times its width from the second and fourth chamber walls 60, 64 as dictated by conventional practice in the microstrip and stripline art, so computer modeling of the interaction of the surfaces may be advisable. Similarly, the spacing between the first microstrip face 46 and the first chamber wall 50 may be closer than the spacing between the second microstrip face 52 and the third chamber wall 56 to a sufficient extent that the term microstrip may be appropriate with respect to at least the first face 46. In part this is because a much larger part of the transmission line energy may be found in the waveguide-like region located between the first face 46 and the first wall 50 than in the like region between the second face 52 and the third wall 56.

The chamber 34 in some embodiments may be arranged with an additional partition that incompletely splits it along its longitudinal axis into at least two longitudinal sub-chambers. The power divider in such embodiments may be located in part on each side of such a partition, with one or more links across the partition between parts of the divider. This arrangement may beneficially serve to provide sufficient microstrip-to-wall surface for dividing the signal power effectively while keeping artifacts such as crosstalk and PIM at low levels. Other embodiments may use a single chamber, may include transverse instead of longitudinal partitions, may have partitions extending entirely across the chamber with feed lines coupling signal power through the partitions at required locations, etc.

Consistent with chamber profile and space constraints, the microstrip 12 may be formed and folded in such a way that a first portion 110 may be proximal to a wall—in the non-RET embodiment in FIGS. 1-3, the third wall 56 of FIG. 2 may be proximal to the first face 46 over the first microstrip portion, also termed the first feed 88, as shown in FIG. 1. After a flat or in-plane right-angle turn 110 and a first so-called easy way bend as shown in FIG. 1 (the latter immediately precedes the first tee junction 96), the first face 46 may be proximal to the fourth wall 64 as shown in FIG. 2. The signal path in some embodiments may be momentarily transverse to the long axis 148 of the chamber 34. A second microstrip portion 112 may have a flat turn 110 and an easy way bend (preceding a tee junction 98), resulting in the first face 46 possibly being proximal to yet another wall, the first wall 64 in the embodiment shown in FIG. 2. In each instance shown, the tee junction 96, 98 may redirect the microstrip 12 to continue proximal to the new wall, once again propagating the signal parallel to the long axis 148 of the chamber 34 and the first portion 110 of the microstrip 12. This arrangement may allow the signal path for the power divider 12 to approximate an equivalent path over a flat ground plane, with added benefits of reducing total enclosed volume and placing the microstrip 12 within a protective enclosure 22. With consideration as to layout, this arrangement can also place all inputs and outputs on preferred faces of the enclosure 22.

In many embodiments incorporating the inventive apparatus, microstrip 12 positioning may include standoff fittings 114, 116, 118 to maintain a substantially fixed spacing between the surfaces of the microstrip 12 and the chamber 34 walls, as well as controlled positioning of the feed tabs with respect to the loop radiator support strips, discussed below. Such standoff fittings 114, 116, 118 can be implemented in a variety of shapes, as shown in FIG. 1, as well as technologies. Regarding technology options, low-density foamed dielectric blocks that partially fill the volume of the chamber 34 at one or a plurality of locations along its length can be fitted around the microstrip power divider before the divider is inserted into a one-piece extruded enclosure 22 from an end. Smaller fittings having greater stiffness can be clipped around the microstrip 12, as represented by one type 116, or clipped into holes in it, as represented by another type 114; it may be preferred to arrange any such holes to introduce minimal effect on propagation characteristics. Fittings made of such materials as low-dielectric-constant polymers may be preferred in some applications, while ceramics and other classes of materials may have benefits such as mechanical strength or stability that can outweigh their typically higher dielectric constants, loss tangents, conductivity, etc.

Other stabilization styles may also be successfully applied, such as metallic-conductor quarter-wave standoffs. While somewhat more frequency-sensitive than fittings using dielectric insulators, shorted stubs can perform filtering and phase adjusting functions as well as providing mechanical stability.

Returning to FIG. 2, in some embodiments, a multiple-piece enclosure/chamber extrusion may be used, wherein a first piece 36 may have a continuous H-section profile. Apertures 120, 122 for respective feeds 124, 126 of a single row of radiators 20 may be used as shown in FIG. 3. These may align with corresponding apertures in one leg of the H-section 36 and may be on opposite sides of the leg-connecting web having faces 60. Attachment hardware may be placed as needed. An H-section profile may simplify assembly. The enclosure 22, exclusive of end walls, may be realized with a second and different extrusion 38, having features such as an extrusion section profile element that interlocks with the terminal edge elements of the H-section extrusion, a directing flange 40 on the radiator side to direct emission in part, one or more mounting flanges 128 on the side opposite the radiator, profile elements for attachment to a second H-section extrusion, some combination of such fittings, etc. A complete enclosure may also include extrusion section cutoff plane top 130 and bottom 132 end closure fittings perpendicular to both the ground plane face 24 and the side wall faces 38. Such end fittings 130, 132 may provide sealing or venting, may be metallic or polymer, etc., as determined by the user for a specific application. In the embodiment of FIG. 1, the bottom end fitting 132 may mount the input connectors 18; in other embodiments, connector 18 placement and number may differ.

To the extent that disassembly for repair may be impractical for some configurations of antenna panels 10 incorporating aspects of the inventive concepts disclosed herein, permanent fixing of standoffs and/or the power divider microstrips 12, 14 to the inside of the chambers 34 may be preferred in some embodiments. Examples of attachment provisions (permanent or otherwise) include adhesives that bond standoffs to enclosure/chamber walls, metallurgical bonding of standoffs to chamber walls, etc. Metallurgical bonding methods may include providing dielectric standoffs to which joining plates are affixed, then providing joining ports through the extrusion and soldering or brazing the plates into place; spot welding the plates, etc. Conductive standoffs may be fixed similarly. Adhesives may be applied to standoff surfaces prior to assembly in order to permit attachment and may afterward be activated chemically, mechanically, thermally, by scintillating or other radiation, or by other means. Such attachment processes may be reversible in some embodiments. Where welding or similar joining methods are used, modeling and simulation may consider possible reflection, reradiation, PIM, etc., by added or deformed conductive materials.

Much of the body of art presently in commercial use—i.e., arrays of relatively low-power radiators driven generally in parallel to form high-gain directional beams—employs either a separate feed line from a power divider to each radiator input node or a TW equivalent. Largely with a view to economy, it is well known to use small diameter polymer-dielectric coaxial cable to connect a divider to radiating elements, provide TW feed, etc. Such cables can have drawbacks. For example, solid or foamed polymer dielectric used in coaxial cables and in some twin lead cables, striplines, and microstrips consistently exhibits higher losses than equivalent conductor arrangements using air dielectric. Also, for a given construction and material choice, coax losses generally increase as diameter decreases.

Coax effectively serves as its own high-uniformity shield, so that it may contain signal energy more effectively than open lines. All things being equal, dielectric-filled coax may have lower loss and higher propagation velocity than comparable (dielectric-filled) stripline, with similar microstrip somewhat more lossy still.

For air-filled equivalents, attenuation in each type can be significantly lower and velocity appreciably higher than with polymer fill, which introduces a tradeoff. Air-filled coax can be much more complex, and thus more costly to manufacture, than air- or polymer- filled signal transmission apparatus of the other indicated styles. Using stripline or microstrip, despite its lossy signal transmission, can keep total price and manufacturing complexity low, even though one or more of transmitter power, receiver gain, filter complexity, and antenna element count for a specific level of performance may increase.

It is submitted that contemporary practice fails to fully evaluate and develop a category of apparatus, namely air-dielectric microstrip. The invention may include novelty at least in providing a fully realized microstrip-fed panel radiator in conjunction with a one- or two-dimensional array of low-cross-coupling, low-mutual-coupling crossed-dipole radiators having polarization determined by feed phase.

FIG. 1 shows such a device. Synchronous-phase input signals typically may produce a single vertically-polarized beam, while a fixed 180 degree phase difference between inputs gives a single horizontally-polarized beam—i.e., axial ratio is infinite in both cases. Where a single circularly polarized output beam (i.e., the special case within the category of elliptical polarization wherein e- and h-magnitude are constant, so that the axial ratio is equal to 1.0) is to be approximated, and the feed structures within the panel to the two sets of dipoles 30, 32 in a single row of radiators 20 are closely matched electrically, a user can apply equal signal waveforms of equal power and a 90 degree difference in phase to the respective panel input ports 18. Relative signal timing between two otherwise equal inputs driving orthogonal radiators largely defines the axial ratio of the far-field beam. In some embodiments, external signal paths from a signal source to two matched input ports 18 can be arranged to differ by 90 degrees instead of being the same or opposite; this allows synchronous-phase signals from a source to be used to realize a circularly polarized beam. Relative input phase setting for such embodiments may use differing-length feed lines, for example, or may use a Magic Tee or other apparatus that inherently or by design generates two outputs that differ in phase by a selected amount, the latter permitting equal-length feed lines to be used. In other embodiments, a single signal source can feed both panel inputs 18, using a signal splitter proximal to or integrated into the power divider. Such a signal splitter may use the aforementioned Magic Tee or another device to control signal phase to the power divider signal paths.

If a first signal is applied to one of the panel input ports 18 and a second signal to the other, where the signals are uncorrelated but on the same channel, then beams formed by the emission of these signals may remain separate and have polarization axes of 45 degrees positive and 45 degrees negative, respectively, until mixed by reflections, which may cause each signal to appear as a noise component in the other. Feed to each input 18 may instead include energy combining two uncorrelated signals in the same channel. Each signal may be phased to create circular/elliptical polarization by setting phase delay to the respective inputs for a first one of the signals to be opposite in sign to phase delay to the respective inputs for the second signal. A beam formed by a panel 10 so fed contains two elliptically polarized signals of the same frequency but opposite handedness. If the two instances of each signal are orthogonal in phase and generally equal in magnitude, then the polarization may approach circular for each. The relative magnitudes of such left- and right-hand polarized signals can be independent.

Single-channel programs, multiple frequency-hopping and/or time-domain multiplexed band-sharing signals over a band, broad-spectrum multiple-channel transmissions, and other applications can be suitable for antennas according to embodiments of the invention, limited by the achieved bandwidth of each complete configuration. Allowable applied and radiated panel power levels may be determined by aperture (panel height), the number of independent radiators operating together, material selection, and heat dissipation due to losses, as well as by regulations. Increased radiator loop 28 material thickness can lower quality factor (Q), i.e., can broaden an antenna's working frequency range. This may also increase reflective losses at all frequencies, i.e., increasing the lowest (best) value of VSWR.

FIG. 3 shows a single radiator and a portion of the feed system therefor. The respective feed tabs 124, 126 may serve as terminal extensions of the terminal nodes/inputs 102, 104 of the microstrips 12, 14. In at least some embodiments, the feed tabs 124, 126 can be separate components joined to the terminal nodes/inputs 102, 104, a process that may permit the microstrips 12, 14 to be inserted from one end into respective closed chambers 34 within a unitary extrusion (combining extrusions 24, 38 of FIG. 2) prior to feed tab 124, 126 attachment. In some embodiments, the feed tabs 124, 126 may be soldered to aluminum microstrips 12, 14 using tin-zinc or other alloy solders, brazed using aluminum-silicon filler metals, etc. These processes may provide effective electrical and mechanical bonds with less thermal stress and temper loss, as well as simpler equipment, than filler metal, spot, or vibration welding, better reliability than riveting, and less labor than screws, although each of the latter and other fastening methods are contemplated as well.

With alternative ground plane configurations, such as an open-backed extruded section, a ground plane fabricated from multiple parts, a ground plane assembled as a series of laterally-mated pieces, the H-configuration described below, etc., employed in place of a unitary extrusion having multiple internal chambers, a group of feed tabs 124 and an associated microstrip 12 can be a single unit. This potentially allows the power division and distribution microstrip 12 to be made by a single cutting step and one or more forming steps, avoiding soldering or other fastening steps that can increase production cost and add to any risk of introducing PIM source locations.

In either configuration, the feed tabs 124, 126 may pass through clearance holes in the panel 24, and may further pass through holes 120, 122 in the base of each radiator 20, then may rise parallel to respective first supporting flat tabs 84, 82, may cross above the respective first monopoles 74, 72, descend along respective second supporting flat tabs 80, 78, and may terminate at a specified distance along the second tabs 80, 78. Where needed for stability, spacing between the riser strips 124, 126 and the flat tabs 84, 82 may be controlled by insulating structural elements 138 in clip or other form, preferably physically small and having a low effective value of dielectric constant so that their influence on electrical performance of the antenna is kept low. Any clips selected for use may attach to the radiators 20 and/or the feed tabs 124, 126 using detents or holes in the conductive elements, may wrap around the parts to any selected extent, may be retained using adhesive, etc., as selected for an embodiment. Setting and/or foaming polymers—in effect, blobs of material—may be used in place of clips. FIG. 3 also shows standoffs 140 between loops 68, 70, 72, 74.

Considering the portion of a microstrip 14 proximal to each radiator 20, each feed tab 126 in conjunction with its respective flat tab 82 may form a first hybrid coupler that may transfer a first portion of its signal energy to a first monopole 72. In conjunction with a second respective flat tab 78, the terminal stub 134 of the feed tab 126 may form a second hybrid coupler that may transfer a second portion of its signal energy to a second monopole 68. The two monopoles 72, 68 may operate jointly as a dipole. Since low loss is associated with high coupling efficiency, riser strip to monopole interface design may be improved by precise initial simulation. While rising alongside a first flat tab 82, a feed tab 126 may act first as a microstrip parallel to a ground reference, then may act as a coupler that transfers signal energy to a core-proximal portion of a loop 74 that has a perimeter length of approximately a half wavelength. Passing beyond this loop 74, the microstrip 126 may traverse an approximation of free space for a distance of approximately a half wavelength, then may form a second hybrid configured to terminate in a tuned stub 134 alongside a second flat tab 78. The effect of an arrangement with accurately selected dimensions may be to couple the largest portion of the remaining signal energy into the second loop 68, with any remaining signal energy being possibly reflected off the termination impedance of the stub arriving back at the first loop 72 in phase with the next cycle of signal energy arriving from the input. Thoughtful layout and simulation can provide an operational design with minimal experimentation. Radiator configuration using crossed pairs of loop-shaped dipoles may be an outgrowth of the invention. The concept may be substantially free of cross-coupling and other artifacts. Disk-shaped parasitic elements 136 may be added at will, preferably aligned with each radiator's beam axis 66 and may be isolated using standoffs 142, and can alter radiator gain largely independently of polarization. A typical parasitic may be ¼ wavelength in diameter for some frequency in the pass band, and may have diameter, thickness, conductivity, and spacing selected according to simulated and tested performance. Multiple parasitics on each radiator may further enhance performance, but typically exhibit diminishing benefit.

In some embodiments, a single input port may be used in place of the dual ports 18 shown. In a simplest embodiment, the second microstrip may not be installed, and the second dipole in each radiator may be unused, resulting in a 45 degree slanted signal polarization. In another embodiment, an internal power splitter may drive a second microstrip with a zero or 180 degree delay, providing a linearly polarized signal, with a 90 degree delay, providing circular polarization, or with an intermediate phase delay that provides elliptical (non-circular) polarization.

Circular polarization may serve linearly polarized receiving antennas at any orientation, albeit with 3 dB less signal than circularly polarized receiving antennas would achieve, while allowing circularly polarized receiving antennas with like polarization to reject reflections. In receiver and transceiver applications, circularly polarized configurations can receive linearly polarized signals, with the received signal strength largely independent of remote antenna orientation. Embodiments may have a single row of radiators, or two or more rows. Where two rows are used, the second row may duplicate the signals of the first row or may carry signals unrelated to those of the first row. Where the signals are duplicated, the remaining input nodes 18 may be driven separately, or with the same single connector and two more feed lines within the enclosure 22 to provide a single linearly or circularly polarized transmitted signal. Rows that are parallel and staggered may show lower mutual- and cross-coupling than those with other relative positioning.

The radiators 20 are described above as being manufactured from any of a variety of materials as preferred for an application. One example is the range of common zinc-manganese alloys, which are quite inexpensive and easy to work with—for example, they use inexpensive material that is readily cast using molds that are uncomplicated and durable. While the intrinsic conductivity of these alloys is low compared to copper, silver, or aluminum, applications that use low or moderate power levels may be essentially unaffected by this attribute. The alloys also accept plating readily, so platings or other coatings in various metals, inherently thicker than skin depth at the frequencies contemplated for these devices, may allow such radiators 20 to have electrical performance approximating that of solid copper or aluminum equivalents.

The radiators 20 may likewise be fabricated from nonconducting or semiconducting materials that accept metallization, as dictated by cost, durability, and suitability to mass-production assembly. In one instance, the radiators 20 and the enclosure 22 may be manufactured from fiber-filled and foamed polymer material, and then plated. If the polymer readily accepts assembly by a method such as gluing or plastic welding, has sufficient ability to withstand weather extremes, and is stable and not self-heating in response to radio signals at power levels of interest, then a virtually all-plastic antenna panel 10 may be provided. This device may transmit and/or receive using only a layer of plating over a “plastic” structure to carry the signals, including the microstrips 12, 14, which may have the properties of air dielectric waveguides when signals are carried between continuous surface plating on the microstrips 12, 14 and the enclosure 22 inner wall. Carbon fiber and nanotube materials as structure and/or filler can be robust and somewhat conductive, and may be used to advantage, even if more costly than zinc alloy. In practice, since the surface, whether plated or not, necessarily functions as the signal conductor in VHF and higher bands, any candidate material may require an adequately smooth surface finish. Particularly where recovery for reuse is infeasible, a “plastic” antenna may be usable for short-duration tasks, even if such a device is not suited for long service. If materials and labor are sufficiently inexpensive, such a device may be disposable or recyclable.

As noted, signals reaching the ends of the microstrips 12, 14 may be further coupled by feed strips 124, 126, preferably with close control of dimensions and thus with scant signal reflection at the transition. The feed strips 124, 126 carrying signals from the microstrips 12, 14 may be parallel to support flat tabs 78, 80, 82, 84, with a selected width and spacing. These dimensions may be viewed as permitting propagation of applied signal power substantially as does a waveguide—that is, any signal above cutoff as defined by the chamber 34 width may propagate readily. Spacing in embodiments of the instant invention between a microstrip face 46 and the proximal chamber wall 50, etc., and their extensions, the feed tabs 124, etc., may strongly affect impedance, while suitability for carrying particular propagation modes, such as TE10 mode, may be affected by chamber 34 width, along with microstrip 46 width, at each point during propagation. The edge walls of a classic waveguide operating in the dominant mode TE10 may be uniformly electrically null, serving to provide structural integrity, air seal, and a barrier against electrical leakage. For this reason, waveguide-type walls may be omitted where not needed, as in some embodiments of the instant invention, leaving the chamber 34, the microstrips 12, 14, the feed strips 124, 126 and the support flat tabs 78, 80, 82, 84 to define a signal propagation path.

The signal paths may effectively turn, at the microstrip termini 102, 104, from a route that may be uniformly spaced away from a chamber 34 wall—specifically, from the inner chamber surfaces 50 that may be the other side of the external ground plane 24 on which the radiators 20 may be mounted—to a route orthogonal to that surface 50. The feed tabs 124, 126 may be soldered or otherwise attached to the microstrips 12, 14 at the latters' termini 102, 104. The feed tabs 124, 126 may exit the chamber 34, with proximal faces of the feed tabs 124, 126 and the support flat tabs 78, 80, 82, 84 may be parallel. Spacing between the feed tabs 124, 126 and the support flat tabs 78, 80, 82, 84 may be substantially the same as spacing between the microstrips 12, 14 and the proximal chamber wall 50, etc., over the part of the path within the enclosure 22. Spacing may be adjusted as required to control impedance and insert additional reactive terms.

The support flat tabs 78, 80, 82, 84 may be at ground potential at the ground plane 24 and may extend perpendicularly thereto along an approximation of the beam direction 66. The support flat tabs 78, 80, 82, 84 may terminate ¼ wavelength from the ground plane 24, with the support flat tab termination possibly having the form of a tee from which two conductors may extend at right angles to one another, then may turn within a plane parallel to the ground plane 24 and may join to define monopole loops 68, 70, 72, 74. The quarter-wave spacing substantially may isolate the loops 68, 70, 72, 74 from the ground plane 24. An associated feed tab 126 may cross over from the first support flat tab 82 to a second support flat tab 78 with a specified conductor length, then may pass along the second support flat tab 78 and may terminate as a stub 134 in the feed tab's characteristic impedance. The second support flat tab 78 may begin at the radiator base 86 (proximal to the ground plane 24) and may terminate 1/4 wavelength away in a tee that itself may begin a second monopole loop 68. Signal coupling from the stub-terminated feed tab 126 to each of the first and second support flat tabs 82, 78 and from the respective support flat tabs 82, 78 to the first and second monopole loops 72, 68 may be a function of the physical dimensions of the feed tab 126 and the stub termination 134, as well as the physical dimensions of the respective support flat tabs 82, 78 and the impedance associated with the spacings between the feed tab 126 and the support flat tab 82 and between the stub termination 134 and the support flat tab 78.

A propagation time for traverse of the distal crossover portion 144 of one of the feed tabs 126 may give the signal applied to the two monopoles 72, 68 driven by that feed tab 126 opposite phase at each moment in time. A consequence of this is that the monopoles 72, 68 may function jointly as a first dipole.

It may be noted that some dipole antenna designs, albeit ones that are generally not closely related to the invention, can provide good radiation characteristics with one monopole expressly receiving a drive signal while the other receives no drive signal, i.e., is effectively at ground potential. In contrast to such designs, the configuration of the invention results in application of a drive signal to both monopoles 72, 68 of a pair 30 (refer to FIG. 1), with reference to the geometric center of the pair 30, at an axis of rotational symmetry 66, with signals that have opposite phase. Effects of the latter configuration include driving the respective monopoles 72, 68 with largely symmetrical excitation energy levels. This may establish an intended low level of cross coupling between the two crossed dipoles 30, 32 of each radiator 20, and may reduce mutual coupling between proximal radiators 20 on a common array 10.

Considering next the proximal feed tab 124—that is, the drive element feeding the two monopoles of the second dipole 32 in each radiator 20—the function of the proximal feed tab 124 may be substantially the same as that of the proximal feed tab 126, except that it may pass between the distal feed tab 126 and the loop elements 28. In at least some embodiments, the propagation path for the signal carried by the proximal and distal feed tabs 124, 126 may be somewhat unequal. Dimensions for the feed tabs 124, 126 can be selected by user preference. In embodiments wherein the feed tabs 124, 126 are respectively shorter and longer than an optimum length, respective feed timings may be slightly different from, although close to, an ideal half-wavelength. This provides an approximation of a nominal beam pattern. In at least the embodiments shown in FIGS. 1-3, the shape of each of the feed tabs 124, 126 may be made slightly circuitous by a series of bends that cause the signal path lengths, and thus the phasing, to be very nearly equal, obviating potential phase error.

Interaction between the two feed tabs 124, 126 may remain small, at least by virtue of the tabs' signal paths being substantially orthogonal. That is, any signal coupled from one of the tabs into the other may tend to induce a current at right angles to the direction of signal propagation for the other, resulting in a slight back EMF in the first tab due to the presence of the second, and vice versa, but little else.

The presence of the “other” tab may be measurable as an impedance lump in each, although more pronounced in the distal feed tab 126. This is because the signal may be present largely as a field between the proximal feed tab 124 and its associated support tabs 84, 82, and between the distal feed tab 126 and its associated support tabs 82, 78. The signal intended to propagate on the proximal feed tab 124 may be oriented away from the distal feed tab 126, while the signal intended to propagate on the distal feed tab 126 may be present largely on the face directed toward the proximal feed tab 124. As a result, the signal on the distal feed tab 126 may be somewhat more susceptible to interaction with the other strip than is the signal on the proximal feed tab 124. Overall, however, signal coupling into each strip from the other may be slight.

In at least one of the related applications referenced above, signal power was phased in a way similar to that described herein, but was coupled using coaxial feed at least in part. As noted therein, it is possible to cause the realized beam direction in embodiments of the invention taught herein to approximate a nominal beam direction using basic dimensions—that is, values for dimensions that closely follow arbitrary center frequencies, ideal propagation rates, simplified assumptions about interaction of dielectric lumps, etc. Slight variations of the basic dimensions, however, can be applied in such a way as to provide a realized beam direction that yet more closely approximates a nominal beam direction. As noted above, one such variation makes the feed strip propagation path lengths almost exactly the same. This can be further enhanced by causing whichever of the two paths is shorter to be the one that has greater capacitive phase delay, for example, so that phase difference due to difference in physical length compensates in part for reactively-sourced phase difference. Similarly, since some embodiments of the radiators 20 include a single pair of pass holes 120, 122, selected dimensions of such radiators 20, such as support tab width, loop perimeter, etc., may be made slightly asymmetrical, with the radiator 20 pass holes 120, 122 providing positive keying to ensure that such asymmetry is uniformly applied and compensates for any demonstrated tendency for a fully symmetric radiator 20 to output an asymmetric signal. Similar keying is possible for punched-and-bent or otherwise fabricated radiators. Optimization of dimensions is preferably realized by inputting accurate initial dimensions into simulation software and analyzing the effect of small changes until a solution within a practical range is reached.

Dimensions of hybrid coupler portions of the radiator loops 28 may be familiar to the practitioner, being extensions of the art taught in the cited related patents and applications. As noted in the present disclosure, adjacent portions of each two loops 28 may be parallel, may have generally matching facing surface widths, and may be spaced apart with a separation selected to form a hybrid coupler. Each facing surface may have a physical length on the order of a tenth of a wavelength for a frequency in the working range for which the radiator 20 is intended. Dimensions for achieving a particular radiative efficacy goal at a given center frequency and bandwidth may be best verified through simulation and prototype testing, including balancing these dimensions with loop height H above the ground plane 24, loop circumference, and other dimensions.

The practitioner may be able to establish a second usable band for a given radiator size. In addition, the perimeter shape for each loop 28 may be square or non-square, but is preferably convex. The characteristic curvilinear perimeter shape of the loops shown herein is not mandatory, but may prove beneficial in minimizing PIM distortion of received signals in the presence of transmitted signals that may be over 100 dB greater in magnitude and located with 5% in frequency. The loops 28 need not necessarily be formed of continuous conductors if one or more additional capacitive or hybrid segments in combination with conductors establish a continuous signal path. Extensive testing has demonstrated, however, that using other shapes, such as the radial straight-line (non-hybrid) monopoles of Wilson et al. or ring-shaped loops as in some much earlier antennas, typically severely degrades the ability of each radiator to support low cross coupling between the dipoles formed by loops 28 in the invention as well as in related previous inventions. Such other (non-hybrid) shapes may also inhibit realizing low mutual coupling between dipoles in proximal but separate radiators. Some designs may render impedance matching in arrays of uniformly-distributed crossed dipoles, such as single-row arrays, two-row staggered arrays, and others essentially infeasible.

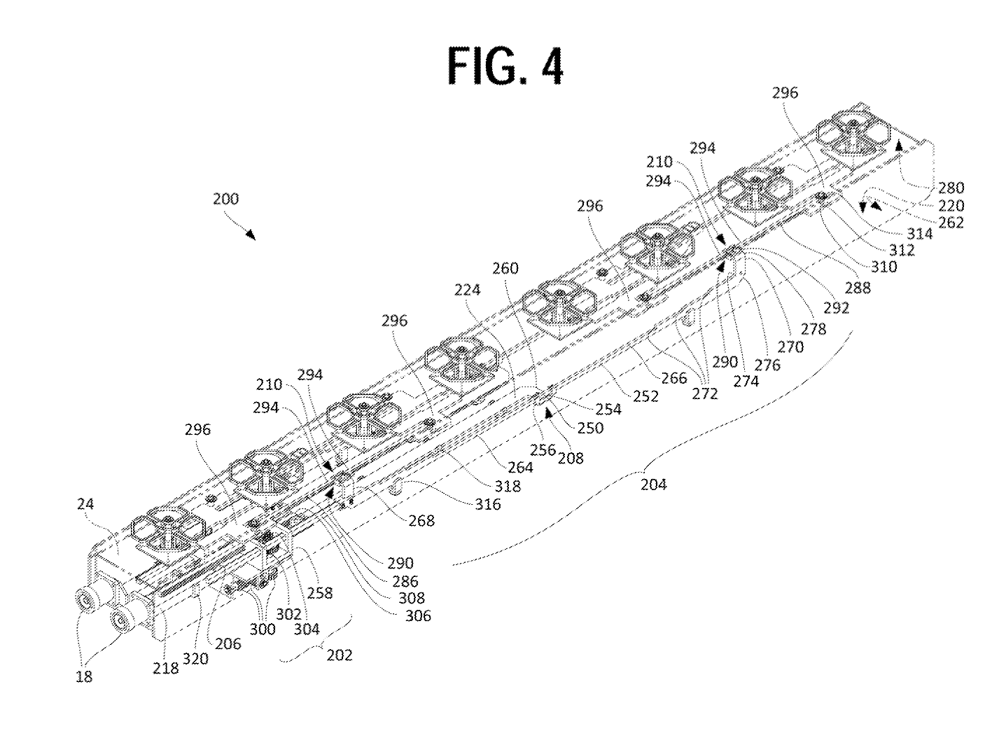

FIG. 4 shows a configuration 200 that may be implemented with features similar to those presented above, that may be implemented with a single row of radiators 20, and adding a provision for dynamically altering power distribution and/or signal phasing from radiator 20 to radiator 20 or from group to group of radiators 20 under control from a local or remote location. One effect of such a change in electrical configuration may be to vary beam tilt; this may be exercised during initial setup of an antenna panel, in response to dynamic variations in operational requirements, etc.

In some embodiments, beam orientation may be set once during installation and never altered. In other embodiments, beam direction may be largely fixed, but may change one or more times over system life as requirements evolve. In still other embodiments, a larger part of signal strength, and its corollary, antenna gain, may be wanted at different elevations over the course of each day. For example, in one application, cellular telephone users may be found predominantly in office buildings during business hours, and down at street level during commuting time and during evening recreational travel. Additionally, absolute numbers of users in specific locales, such as business core areas and substantially residential areas, may vary between normal workday hours and evening hours, for example, lowering signal processing load. Thus, with numbers of potential users within a cell varying from time to time in a predictable way, frequently changing effective cell size by tilting antenna beams up or down may be justified. While a cell enlarged by tilting upward may have lower signal strength at its outer extent, a gross reduction in signal traffic may permit a cell having reduced signal strength to meet requirements for a particular time of day. Some applications may permit low-use cells to be shut down while others expand coverage to fill in. The concept may also improve coverage or reduce outage extent during cell failures. While transmitter power and receiver gain may also be adjustable, beam tilt is a recognized adjunct to such signal processing changes.

Each panel having a vertically-placed array of radiators has not only a specific, albeit adjustment-dependent, beam strength as a function of elevation, but also a specific beam width that depends largely on radiator design. Wireless telephony cells and other application of such antennas may commonly be configured with a plurality of panels pointing outward around a common center, and may realize, for example, a generally omnidirectional pattern within an array of such cells over terrain. For such applications, the above description of transmitter signal strength, receiver gain, beam elevation alteration and the like can be selected to be different for each panel, by time or by extent of elevation, rather than being uniform. This may be dictated by the requirements of a specific location or limited by regulation, for example.

It is to be observed that each of the respective radiators 20 in the embodiment shown in FIG. 4 may include a disk-shaped parasitic radiator 136 distal to the ground plane 24. The parasitics 136 may serve to alter propagation performance in a variety of ways, such as to narrow beam width, to increase radiator axial gain, to reduce sidelobe energy content, to increase bandwidth, to decrease Q, to modify VSWR, etc.

The single-row crossed-dipole radiator panel 200 embodiment of FIG. 4 shows two “ 7/16 DIN”-style input connectors 18 selected for mounting on an end face 132. The connector type indicated, suitable for such applications as cellular telephony up to 7.5 GHz with moderate power, should not be viewed as limiting. Beam tilt adjustment in the embodiment shown may use a motorized gear reducer 202 that may use a two-stage worm-and-wormgear reduction mechanism to alter relative positioning of elements in a pair of multisegment microstrip power dividers. Other types of adjustment devices are contemplated as well. Each power divider may provide excitation to all of the radiators 20 in the array 10, but may only provide excitation to a respective one of the two dipoles 30, 32 in each radiator 20.

The term “wormgear” is used herein—as it is substantially universally used in mechanism arts—to describe a specialized gear adapted from a spur gear, with a tooth form conjugate with and driven by a worm, where the worm may be a gear with one or more teeth or “starts” that advance helically around an axis, as defined in ANSI B6.9 (various editions) and elsewhere. Terms such as rack, pinion, and spur as used herein likewise carry their ordinary meanings from the mechanism arts. Similarly to the connector type, drive mechanism details such as materials, gear ratios, component sizes, strategies for combining worm and rack-and-pinion drives, etc., should not be viewed as limiting.

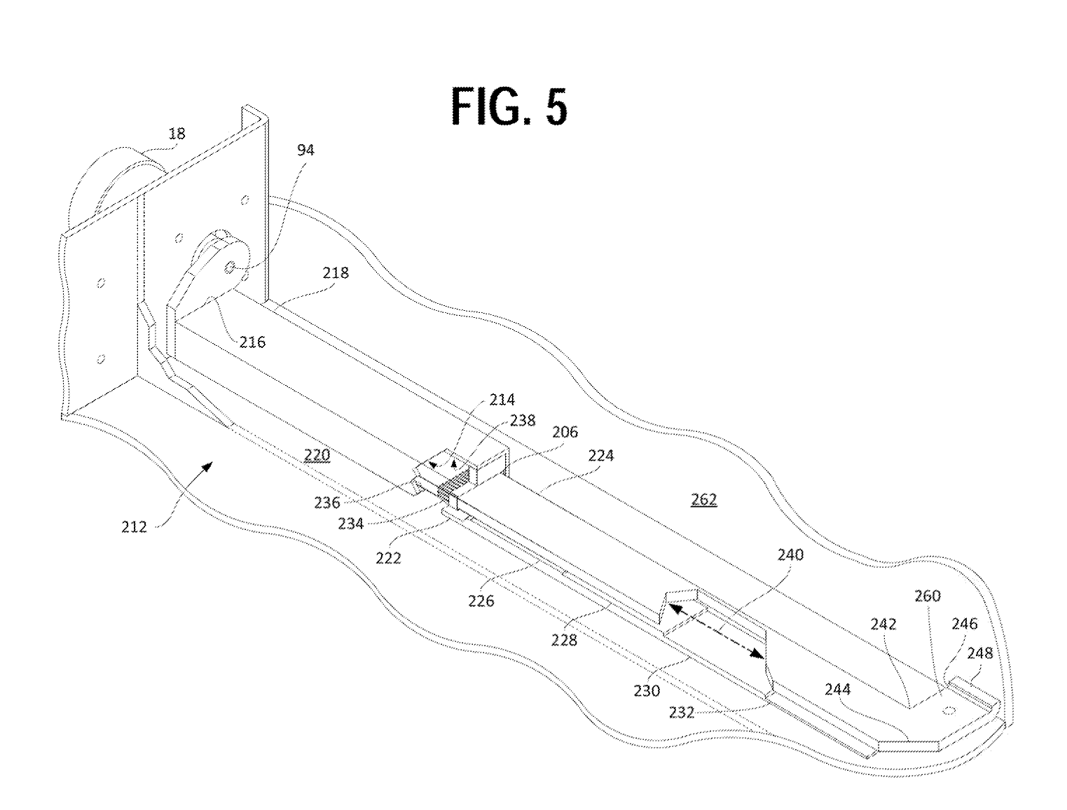

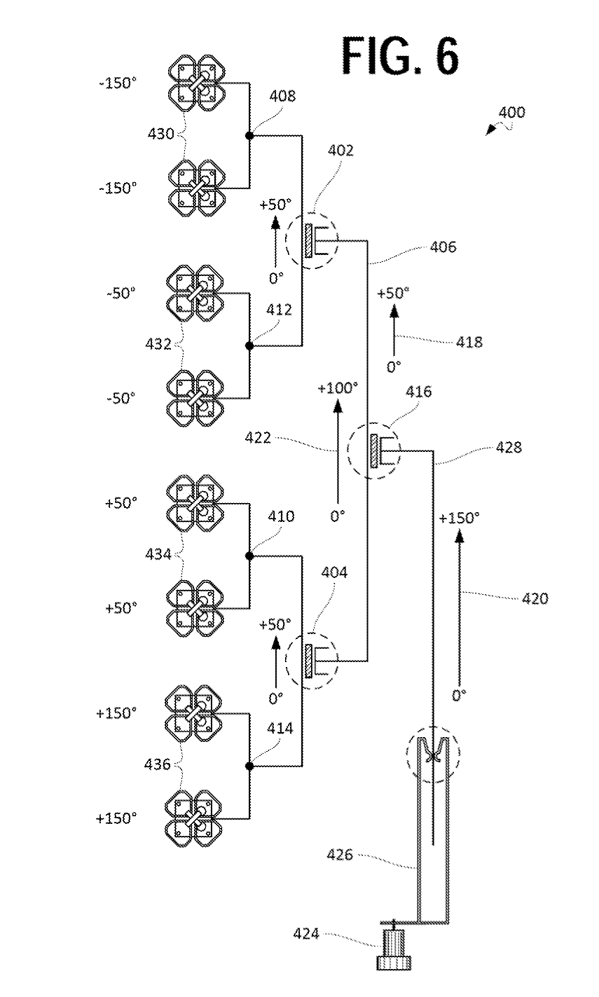

Each power divider may be understood as approximating the totally open air dielectric folded microstrip distribution structure 16 shown in FIG. 1, adapted to support remote electrical tilt (RET) for phase shifting as indicated in the distribution structure 204 of FIG. 4. Phase shifting is generally nominally uniform from signal path to signal path, and may be accomplished through a plurality of slideable joints, one of which may be a conductive coupling joint 206 and three of which may be edge-oriented capacitive-coupling joints 208, 210, the joints may be components of a corporate feed network that may be contained within a chamber 212, shown in FIG. 5. The chamber 212 may share structure to any selected extent with a ground plane 24; in some embodiments, the ground plane 24 may be one outside face of a single extruded piece of which one or more chambers 212 are interior spaces. The ground plane 24 may serve such functions as emitted signal reinforcement.

The conductive joint 206 in the embodiment shown may be configured to provide low-loss signal transfer through a constant impedance sliding contact, while the capacitive joints 208, 210 may likewise provide low loss, approximately constant-impedance signal transfer. Recourse to two signal transfer arrangements may address two different functions. In the case of the conductive joint 206, research and simulation of a host of alternative configurations reliably produced somewhat less desirable return signals, PIMs, and other defects, while the arrangement shown proved to be unexpectedly effective. For example, a classic coupling circuit that might permit motion places two microstrip elements edge-parallel within a chamber. Widely spaced in air, they can couple a small portion of an applied signal, and produce signal defects at virtually all positions. Closely spaced and separated by a thin, high-numerical-value dielectric element, they have increased coupling but still have position-dependent signal transfer behavior. Placed one atop the other—that is, width-parallel—produces negligible improvement. Making the proximal surfaces conductive and placing them in contact produces different, but abundant, failure modes.

The successful solution in FIGS. 4 and 5 may use a coaxial signal line, air-filled or otherwise, may be impedance-adjusted by stepping the outer diameter of the inner conductor while possibly leaving the inner diameter of the outer conductor constant. This may ease manufacturing and assembly compared to the electrically equivalent opposite case, where the outer conductor inner diameter is modified and the inner conductor outer diameter is constant. Additionally, applications such as termination of a unit of coaxial cable to a standard connector, wherein both inner and outer conductor diameters may change at the same locus, with potentially negligible impedance change and reflection are also contemplated. One aspect of the invention may be maintaining constant impedance at a step change in dimensions of a microstrip by changing the height of the proximal ground-referred surface at the locus of the height change. This may allow a constant-impedance sliding joint to be implemented by sliding one element inside another. Any desired impedance changes can be implemented separately from the sliding joint. Several variants are feasible, as will be noted.

FIG. 5 shows the conductive joint 206 in greater detail. Following the input node 94, and after an “easy way” bend 216 or equivalent joining of pieces, the first segment 218 may be placed at a fixed position above a proximal face 220 of the chamber 212 (i.e., the interior of the conductive enclosure 22, FIG. 1). The segment 218-to-face 220 spacing may define a fixed impedance therebetween. Since the impedance of a microstrip segment may be largely a function of the distance between a segment 218 face and the proximal chamber surface 220, the segment 218 width, and the dielectric constant (of air, approximately ε_{0 8}), a transition to another conductive segment (224 in this embodiment) may have a different height above the chamber face 220 and may tend to be mismatched. However, impedance matching, can be realized in by attaching a conductive shim 222 to the proximal chamber face 220 at the locus of transition—i.e., the conductive joint 206—from the first segment 218 to the second segment 224. In the embodiment of FIGS. 4, 5, and 7, the conductive shim 222 may have a height selected to provide a constant-impedance transition between the first segment 218 and the second segment 224.

If a user elects to have the second segment 224 continue at the same height above the proximal chamber face 220, then a series of steps in shim height down to zero can adjust the impedance, allowing signal routing without further shims. In other embodiments, shims may be used between the second segment 224 and the proximal chamber face 220 throughout the length of the second segment 224, for example. Where stepped shims 222 are used, as in the embodiment shown, the number of steps—properly viewed as transformer stages—may be directly related to the shims' effect on bandwidth. That is, the more stages, the broader the band over which a transition zone has good loss behavior. For example, in one aspect using four stages—transition from first 226 to second 228, then second 228 to third 230, then third 230 to fourth 232 shim heights, then from the fourth 232 and lowest height to the chamber surface 220—can achieve about 25% bandwidth, using a criterion such as having VSWR below a selected threshold, e.g., 1.2, in the 2 GHz range, specifically between 1.71 GHz and 2.17 GHz. If shim 222 width is sufficient to exceed a threshold defined by other dimensions of the circuit, it may affect bandwidth to only a negligible extent.

As implied above, the height of the initial shim section 226 may be determined in part by the difference in width between the first 218 and second 224 segments. Each shim section's length in the signal propagation direction—the spacing between the transformer stages that correspond to the shim steps—may be beneficially at least long enough for the transformer stages not to interact significantly. A rule of thumb for this length may be at least ¼ wavelength of the lowest (longest-wavelength) frequency carried in the apparatus, in view of the propagation velocity.

That part of the first segment 218 after the easy way bend 216 may be formed as a hollow rectangular prism with an interior chamber 214, such as by using a section of waveguide as the raw material therefor. The second segment 224 can be configured to be inserted part way within the first segment 218. The joint between the two segments can constitute a conductive slip coupling. Attaching so-called finger stock 234, which may be spring brass or similar material in some forms, at least to the end of the bottom inner wall 236 (shown with a cutaway) of the first segment 218, can provide an effective realization of a conductive slip coupling at least in part. The finger stock 234 can press the second segment 224 up against a low-drag wear strip or similar conductive or insulating element on the end of the upper wall 238 of the waveguide/first segment 218.

Alternatively, a fixed (non-resilient) conductive rub strip can be placed where the bottom finger stock 234 is located in FIG. 5, while a resilient component on the upper face 238 may press the second segment 224 down to achieve conduction. Other mechanical sliding arrangements can be used to accomplish a similar goal. The “waveguide” material shown may be replaceable by a segment of similar material that is open-topped, i.e., channel-shaped, or flat, although exposed parts of the second segment 224 potentially may radiate or otherwise generate PIM distortion. Any such arrangement option can provide signal path continuity as the second segment 224 moves.

The first segment 218 may remain stationary over a fixed area of the chamber bottom surface 220, and thus may have a fixed first impedance, while the part of the second segment 224 that protrudes from the first segment 218 (“waveguide” configuration) may have an impedance that does not vary as the second segment 224 may extend and retract with reference to the first segment 218. This permits the second segment 224 to translate along an insertion axis 240 over an arbitrarily long scope without interfering with the impedance matching established by the transformer stages 226, 228, 230, 232. In embodiments such as that shown, the second segment 224 may insert within the first segment 218, making the former possibly somewhat narrower. Any resulting impedance lump may be compensated by having the first shim 226 slightly higher, i.e., closer to the second segment 224, than would be required for segments of equal width, making the capacitance per unit length for both segments, and thus the impedance across the sliding joint, substantially constant. Fine-tuning the first shim 226 height in simulation and test may further refine the embodiment. In other embodiments, the impedance of the second segment 224 may be adjusted using a tapered shim and may achieve an electrical effect similar to that of the stepped shim 222.

A distal part of the second segment 224 may be further adapted to meet power divider requirements. Such adaptations may include changing its width and/or thickness (i.e., its impedance; this is not shown in FIGS. 4 and 5), making a square, flat (i.e., in the plane of the second segment 224 width dimension) turn 242 (with a corner chamfer 244 for substantially uniform impedance), making an “easy way” bend 246 (i.e., a bend that directs the microstrip 224 out of its previous width plane), etc. It is to be noted that the second segment 224 as represented in FIG. 5 may be truncated in a way that could cause an impedance lump near the turn 242; the greater length shown in the representation in FIG. 4 has been verified in simulation and test.

In the embodiment shown, the second segment 224 termination 248 may be located at a capacitive joint 248 in the vicinity of the midpoint 250 of a third segment 252, as shown in FIG. 4. In embodiments such as that shown, the second-to-third-segment capacitive joint 248 can be established by interposing a thin insulating shim 254 between the second 224 and third 252 segments, using a material such as a high-dielectric-constant ceramic, and by surrounding the joint 248 to a selected extent with one or more retaining components 256 made from an insulating material such as a polymer that has a relatively low dielectric constant. Since this is a movable joint, it may promote long component life to select ceramic and polymer materials that achieve a low net coefficient of friction between the second 224 and third 252 segments, thereby reducing wear and drive mechanism 258 loading.

The second (first capacitive) joint 248 can be viewed as a tee junction wherein the input leg 260 (the end of the second segment 224) may have a first cross section and may have a specified spacing from a first grounded face 220, and, after its bend 246, from a second grounded face 262, the chamber-side surface of one of the end closure plates 130, 132. The input leg 260 thus may have a first impedance. Similarly, each of the matching output legs 264, 266 may have a second cross section, and, in the embodiment shown, may have the same spacing from the second face 262. Judicious selection of dimensions may allow the parallel combined impedance of the output legs 264, 266 to be equal to the impedance of the input leg 260. If the portion of the third segment 252 over which the terminal joint 248 can traverse, plus an additional ¼ wavelength to each side, has a constant cross section and spacing, then a low nominal value of VSWR at the joint 248 can be maintained over the full traverse.

The distal extents 268, 270 of the third segment 252 may have features related to those of the distal extent 260 of the second segment 224. That is, the third segment 252 can be positioned at a uniform distance from a chamber wall 262, can change width in at least one step 272, which may set a selected output impedance, can have a flat-way square turn 274 with a chamfered or other uniform-impedance corner 276, can have an easy-way bend 278 to transfer the primary signal-carrying face of the microstrip to be proximal to another face 280 of the chamber 212, and/or can terminate at each end with a joint 210 that couples the third segment's signal content to two other segments, the fourth 286 and fifth 288, respectively. As in the second-to-third joint 208, the third-to-fourth and third-to-fifth joints 210 can have thin, high-dielectric-constant ceramic shims 290 and may have surrounding polymer fittings 292 that provide stabilization and permit low-friction motion. Also as in the previous joint 248, the input impedance of each capacitive joint 210 can be dimensioned to match the output impedance thereof by selecting dimensions of the tee outputs 294 so that their parallel impedance equals the impedance of the respective inputs 268, 270. As in any such realization, impedance matching may be finite, but can be closely approximated over production tolerances and environmental stresses by simulation and test.

Table 1 illustrates the phase relationship in a representative panel 200 between four intermediate outputs 294, each of which carries a feed to a fixed, final divider 296 that may split its signal energy, nominally equally and in phase, between a proximal pair of radiators 20. Causing motion within the second-to-third segment joint 208 may alter the signal phase between the two ends 268, 270 of the third segment 252 while possibly minimally affecting power level and impedance. The same applies to outputs from signals transiting from the third segment 252 to the fourth and fifth segments 286, 288. That is, motion of the third segment 252 alone may shift the relative phase on the two outputs 294 of each joint 210 by equal amounts, leaving power and impedance substantially unchanged.

The two moving segments 224, 252 in each of the two chambers 212 may be driven by a common gear train 300 except possibly for the final pinion 302, idler 304, and racks 306, 308. Using a fixed ratio, such as fixed 3:1 ratio, causes the phase of each proximal pair of radiators 20 to advance with respect to that of the other pairs in proportion to motor shaft rotation. Note that Table 1 refers to the reference numerals used to point out individual nodes in schematic FIG. 6.

TABLE 1
Phase Relationship Between Outputs (Degrees)

| Disp (420) | Out (414) | Out (410) | Out (412) | Out (408) | Tilt |
|---|---|---|---|---|---|
| 0.0 in | 0° | 0° | 0° | 0° | 0.0° |
| 1.0 in | −60° | −20° | +20° | +60° | 3.3° |
| 2.0 in | −120° | −40° | +40° | +120° | 6.7° |
| 3.0 in | −180° | −60° | +60° | +180° | 10.0° |

Table 1 further indicates that a summary tilt angle may be achieved that may be proportional to the combined phase change and is a function of mechanism position. For any intended tilt angle, the user can command, drive, and sense a specific motor rotation using a processor, a power source, a rotary encoder or like measuring device, one or more end-of-travel sensors, etc., to apply a motor-compatible level of power until a selected tilt angle is achieved, and then stop.

Some worm drive mechanisms, including that shown, have high enough gear ratios to be self-locking, i.e., to resist being driven from the wormgear side, particularly when two worm drives are cascaded as shown. Selection of gear ratio depends on such factors as available power, selected motor size, and desired speed of adjustment. Some motor controllers can apply power according to internally-derived time-of-day scheduling, sensor data, etc. Control apparatus may be as simple as a remote command sent via a moderate-power differential logic signal able to drive the motor directly, with the command passing through paired end-of-travel switches, so that the current passes through the motor until interrupted by the mechanism reaching end of travel, where it halts until the command signal reverses polarity.

The indicated embodiments should not be viewed as limiting, since any of several types of actuation mechanisms and position sensors may be applied. While the embodiment implied in the table has four discrete positions, each of which may be associated with a switch closure, a motor shaft encoder pulse count, etc., other embodiments can be limited to two positions, as in the above example, or another number of discrete positions, or can be dynamically or continuously variable based on a criterion such as remote measurement of transmitted-signal power, a usage calculation derived from cellular base station traffic loading, cell or panel shutdown announcements requiring beam range alteration, etc.

A thin layer 254, 290 of high-dielectric insulator material, such as a ceramic material 0.8 mm (0.03 in) thick, εᵢ=50, may be fitted between each two of the conductive components 224, 252, 294 at respective coupling joints 208, 210, although not at the “waveguide” joint 206 in the embodiment shown in FIGS. 4 and 5. Where used, the insulator 254, 290 can act to electrically narrow the gap of the joint, to lower loss, and to achieve a microstrip capacitive coupling in each joint 208, 210. For example, by moving coupling joint 208 at a first rate and moving coupling joints 210 in the same direction, at a rate one third as fast, a continuous phase progression can apply a signal to (or equivalently to receive a signal from, or both) an eight-radiator array. It will be observed that the embodiment shows each two radiators 20 may be coupled by a fixed feed component 294 via a tee 296, so four distinct values of phasing may be realized in the embodiment shown. This multipoint phase progression may provide progressive beam tilt over a range that is wide enough to be useful, while realizing slight and continuous gain variation over the tilt range.

A typical tilt range over which an embodiment may be adjusted maybe roughly 10 degrees; Table 1 indicates simulation results over a three-inch (76.2 mm) span that is not a performance limit. The travel in Table 1 is approximately related to a 1.9 GHz signal (roughly six inch wavelength, assuming signal propagation approaches the speed of light in free space). Other embodiments may be limited to a narrower range. For example, using two sub-arrays of four radiators each, in an upper half/lower half configuration, instead of four sub-arrays of two radiators each as shown in FIGS. 4-7, generally may limit tilt range to about two degrees before beams from the sub-arrays become incoherent. Other embodiments may support beam tilt of fifteen degrees or more.

It is to be understood that Table 1 and the figures herein are not to be viewed as limiting; a variety of configurations can be realized by changing the number of radiators, increasing the number of moving segments and the associated routing mechanism such as gearing, etc. For example, using only one moving segment, an eight-radiator panel can have two sub-beams. The two sub-beams may be separated in phase by only about 0.01-0.02 cycles before loss of signal integrity takes place. The small phase separation may be sufficient to cause a net beam tilt angle of two degrees, potentially a useful amount of tilt, but insufficient for many applications. In yet another example of an eight radiator panel, three gear ratios can drive a second (first moving) segment, a third (second moving) segment, and two fourth (“third moving”) segments, with the ratios of motion of the moving segments determined by a goal of tilt angle deflection in excess of ten degrees. With eight continuously adjustable phase angles, each of the eight radiators may be driven by a signal having a unique intermediate phase. Such an arrangement may not fit in a straight-line chamber, so the two “fourth” segments may require a more elaborate serpentine configuration to avoid increasing radiator spacing; this last can cause grating lobes to occur. The added design complexity of an eight-phase panel may be unnecessary, since ten-degree tilt is a common requirement readily achieved with an eight-radiator panel in which proximal pairs of radiators have like phase shift.

An additional aspect of the sliding-joint edge coupling provision of the capacitively coupled joints 208, 210 may be incorporated in embodiments of the instant invention is the absence of step width changes and protrusions proximal to the sliding joints. Steps and protrusions may typically be used proximal to sliding joint locations in apparatus not incorporating aspects of the invention, in order to enhance coupling. However, the use of steps or protrusions has at least the possible drawback of creating impedance mismatches, which, when a sliding joint is moved, can alter system impedance as measured from the system feed side and/or from the radiator side. In addition, power division ratios between input and output tend not to remain fixed in configurations that use steps and protrusions for phase adjustment. Such variations can decrease antenna efficiency.

FIG. 6 shows feed progression 400 in schematic form. Consider first the two final joints 402, 404. As shown in schematic form, each may be enabled to advance from a first position to a second that is “up,” i.e., away from the input connector 18, with reference to some other position. The amount of travel, in this illustration, is 50 degrees, i.e., slightly over ⅛ wavelength, a distance readily measured along the microstrip with reference to the propagation rate of the signal along the microstrip. As the third segment 406 moves upward, the distances from the joints 402, 404 to the uppermost and third-highest pairs of radiator feed points 408, 410, respectively, continuously may decrease, while those to the second-highest and lowest pairs 412, 414 may continuously increase. In all cases, phase shift may be continuous and substantially linear, provided the dimensions of the third segment 406 are uniform as noted above. Both impedance and power division can remain essentially constant, provided the third segment 406 includes at least an additional quarter wavelength of uniform-width microstrip feed line on beyond each extreme of travel before the occurrence of a step or protrusion.

The feed signal to the above-discussed final joints 402, 404 may come from the first capacitive joint 416. The first capacitive joint 416 may be the distal termination of the second segment 428. This corresponds to the second segment 224 of FIG. 5, wherein the gear train 300, 302, 304 driving the racks 306, 308 may cause the second segment 428 and its associated capacitive joint 416 to travel physically at three times the rate of the third segment 406 and final joints 402 and 404, with a motor 440 linked at a first rate to the first segment 426 and through an additional extent of reduction 442 to the second segment 428. The sliding joint 438 likewise corresponds to the joint 206 pointed out in FIG. 4 and shown in cutaway in FIG. 5. This establishes correspondence between the embodiments shown physically in FIGS. 4 and 5 and shown schematically in FIG. 6. As the final joints 402, 404 move by a physical distance corresponding to 60 degrees 418 of signal phase, as referenced above, the first capacitive joint 416 may advance by 180 degrees 420, so that the net signal phase shift 422 at the first capacitive joint 416 relative to the final joints 402, 404 is 120 degrees. The movement of the third segment 406 decreases the signal phase distance from the input 424 to the feed points 408, 412 of the upper four radiators 430, 432 by the same 120 degrees, while increasing the distance to the feed points 410, 414 to the lower four radiators 434, 436 by a like amount. As in the case of the final joints 402, 404, the shift in phase can be made continuous and substantially linear by providing a lack of steps and protrusions within ¼ wavelength of the joints 402, 404, 416 over the full range of travel. As described above, the first segment 426 can be understood as mechanically fixed and having generally invariant electrical characteristics. Phase angle values in FIG. 6 and Table 1 are to be construed as primarily pedagogical. Other angle values are within the spirit and scope of the invention and are contemplated as well.

It is to be noted that the behavior of air-surrounded microstrip signal distribution devices may be contrasted with that of dielectric-filled coaxial cable, which is extensively used in some array antenna designs. The use of dielectric fill material in place of air fill generally increases signal attenuation (losses) as a function of the dissipative character—i.e., loss tangent—of the material, and is similarly related to the dielectric constant of the material. Thus, a low-density foam made by expanding a low-dielectric-constant polymer with a low loss tangent might attenuate a signal minimally (per unit of length), while a high-dielectric-constant ceramic with significant metal or other inclusion raising its loss tangent might have much higher losses per unit length. The drawbacks of some low-density dielectric fill materials also include durability and dimensional stability, while some high-density materials can demand more robust mounting provisions and may be frangible. Air fill may approach zero losses from such factors, with a limited exception of water vapor, pollution particulates, and other contaminants. Use of durable standoffs, spacers, and the like to maintain relative position between conductors may require some adaptation of designs.

Filled coax can have a signal propagation rate as low as or less than 75% of light speed for some combinations of materials and sizes. Signal velocity in air-surrounded microstrips such as those presented herein approaches a value of 1/\sqrt{LC}. That is, signal velocity with air dielectric depends largely on the inductance and capacitance of the conductor structure. Velocity may be shown to be substantially independent of conductor surface conductivity, except as conductivity affects reactance.

In addition, velocity, like signal loss characteristics, may be affected by the dielectric constants of insulating materials. Both may be found to manifest primarily at coupling fittings at edge-to-edge joints and in proximity to support fittings. Guides 316, 318 and support fittings 320 may be selected and incorporated in such a way as to have slight effect on signal propagation, such as by being made of low dielectric constant, low loss tangent materials, by being physically small, and/or by being located primarily distal to high-current surfaces of the microstrip segments they guide and/or support.

Where design considerations dictate the presence of support fittings, the effect of such impedance lumps as they introduce may be kept slight by adding compensating lumps. For example, in FIG. 4, a microstrip segment proximal to the topmost final tee 296 may be located in part by inserting a polymer resilient standoff 310 having a selected dielectric constant into a mounting hole in the segment. The dielectric properties of the standoff 310 may introduce capacitance that is not fully offset by the scant inductance of the mounting hole, but additional compensation can be provided by a variety of provisions. A narrow notch 312 in the microstrip segment is shown; this notch acts, in effect, as a reverse protrusion, adding an amount of inductive reactance that may keep the net phase shift attributable to the support fitting 310 low. The embodiment shown uses a metallic non-threaded retention device 314 to hold the standoff 310 in place; this should not be seen as limiting. Other constructions are contemplated as well.

Air-filled conductors may also be coaxial, while microstrip may be produced in the form of copper strips on FR-4 and other media. Microstrip on FR-4 may be seen as dielectric filled, and has propagation rate and dissipation characteristics similar to coax having comparable fill. Air-filled coax can be in some ways electrically superior to air-filled microstrip and stripline. Drawbacks to air-filled coax can have more significance than electrical performance. These include cost, manufacturing complexity, and assembly labor, particularly where multiple impedance changes are required. A tee junction may be followed by a plurality of step width changes in microstrip, for example. Such a junction in coax would likely be followed instead by a plurality of inner or outer conductor diameter changes, which are generally viewed as relatively difficult and costly to produce with low PIM. Thus, microstrip, compared to coax, may prove to be particularly effective for combining good performance (low loss, low PIM) with low production cost.

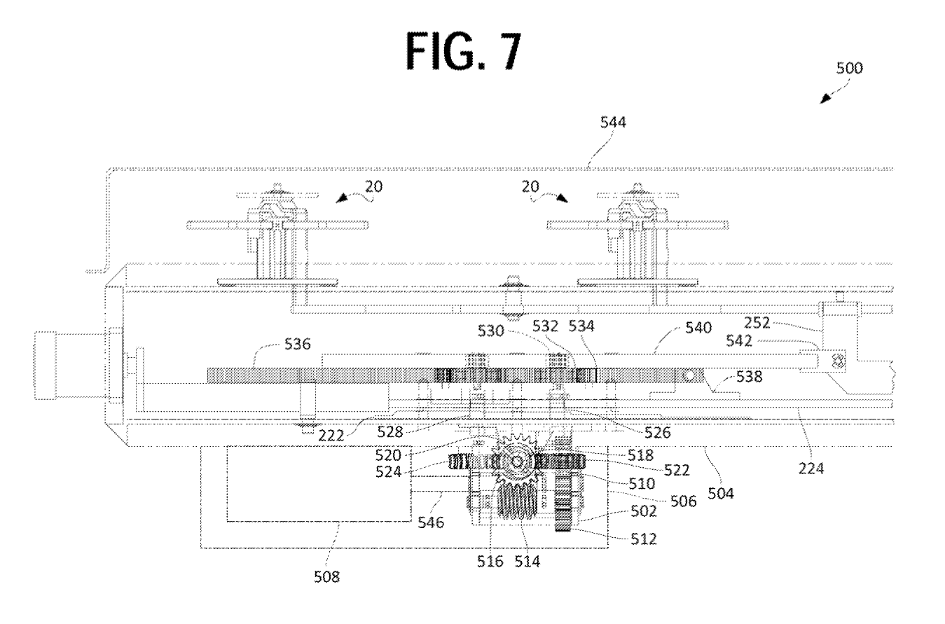

FIG. 7 shows a partial side view of a power divider 500 using a representative gear box 502, with the divider enclosure 504 and the gear box shell 506 in phantom. A motor 508, by way of a coupling shaft 546, may drive spur gears 510, 512 that in turn may drive a first worm 514. The first worm 514 may engage a first wormgear 516. The first wormgear 516 output shaft 518 (directed toward and away from the viewer) may drive two second worms 520 (view of the distal worm is obstructed by the first wormgear 516). The proximal second worm 520 may drive a second wormgear 522, while the distal second worm may drive a third wormgear 524. The respective output shafts 526, 528 of the second and third wormgears 522, 524 may connect to duplexed pairs of pinion gears 530, 532. In the embodiment shown, a tooth pitch diameter ratio between the pinions of 3:1 provides the selected motion ratio between the two moving tuning elements (the second segment 224 and the third segment 252) discussed above. Other ratios are contemplated as well. An idler pinion 534 may transfer the motion from the larger (and faster tooth rate) pinion 532 to its rack 536, which in turn may be pinned to and may drive an adapter 538 that may be pinned to and may drive the second segment 224, while the smaller pinion 530 may drive its rack 540 (and, through another adapter 542, the third segment 252) directly.

The ratio selected for the embodiment shown should not be viewed as limiting. Indeed, while the ratio shown uses similar-pitch 12-tooth and 36-tooth pinions 530, 532 to achieve an exact 3:1 ratio in displacement between two racks 536, 540, any possible diameter ratio of similar-tooth pinions 530, 532 (e.g., 32:11 yields 2.909, 35:12 yields 2.917, 38:13 yields 2.923, etc.) may be optimum for a particular relative travel ratio between the second and third segments 224, 252 in the power divider 500. Further, still other ratios may be achieved by using a first rack-and-pinion having a first pitch and a second rack-and-pinion having a second pitch, instead of using the same tooth pitch for both as shown. Ratio flexibility may be limited by availability of off-the-shelf pinions having particular pitch and tooth count and of mating racks. Additionally the components may have polymer and filler constituents selected in view of dielectric constant and loss tangent goals. Custom part engineering may be practical where economical.

Materials other than filled polymers—metals, ceramics, etc.—may be preferred for some components where conductivity, high dielectric constant, lossy response, brittleness, need for lubrication, or another material property is not detrimental to or is a factor in successful operation. Where such properties are undesirable, materials such as G10 glass-fiber-filled epoxy and its fire resistant equivalent, FR4, having moderate dielectric constant (on the order of 4.3), low loss tangent, and high strength, may be adequate. Polyoxymethylene (POM), also known by names including acetal, is a thermoplastic having some properties, such as moldability and self-lubrication, which may be superior to those of G10 for some applications, specifically including gears. For the sliding junctions described above, thin fittings 254, 290 may have high dielectric constants, the fittings 254, 290 may be interposed between the conductive elements, can improve signal coupling performance over air gaps or low-dielectric-constant materials and may lower PIM performance compared to conductive contact. Ceramic materials have been developed that have attributes such as dielectric constants ranging up to 90 or greater, and that retain mechanical and other properties that are acceptable. One or more materials with dielectric constants on the order of 50, for example, can be used for embodiments including those shown herein.

The larger pinion gear 532 may drive an idler 534 to reverse its direction of rotation. The smaller pinion 530 and the idler 534 each may drive one of two racks 536, 540, with the idler-driven rack 536 possibly being positioned on the far side of the idler 534 (see FIG. 4). This positioning may cause the idler-driven rack 536 to move three times as fast as the directly-driven rack 540, but in the same direction. Using the same size pinions (530 and idler 534) to drive both racks 536, 540 ensures similarity of mesh.

A radome 544, shown in phantom in FIG. 7, may be included in order to enclose the antenna panel radiators 20, largely for weather protection, but, additionally, for other purposes selected by a user, such as, where not transparent, to conceal the radiators from view. A single extruded, bent, or vacuum formed sheet of polymer or other material may be selected for its dielectric and weather-resisting properties that can freely pass radiation to and/or from the panel 10 while blocking rain and contaminants from the radiators 20 and the feed system 12, 14. Including a radome 544 may allow the feed strip pass holes 120, 122 (FIG. 3) to be left open, for example, rather than requiring an individual barrier seal in each. A radome 544 may also guard the individual feed strips 124, 126, parasitics 136, and any support fittings 140 used to stabilize the feed strips 124, 126 from being damaged by impacts of wind-blown objects, animal contact, etc. Top and bottom faces of a radome 544 may be integral with side walls and a single surface distal to the ground plane 24, through which distal surface most radiation passes, or may be separate parts. Since the top, bottom, and side walls of a radome 544 may not be major factors in propagation, any of these may be conductive, either integral with or separate from the ground plane 24. In embodiments wherein any of these is conductive, the conductive component may affect beam focus and elevation. Some embodiments may incorporate a plurality of more-conformal radome shapes or separate radomes for individual radiators or groups of radiators mounted on a ground plane 24. Conductive, resilient, or other forms of closures 130, 132 may be affixed to the top and bottom openings of the chambers 34 behind the front surface of the ground plane 24. Downward-facing radome 544 and chamber 34 openings may be completely uncovered or have covers that include open vents or so-called weep holes in some embodiments not requiring pressurization.

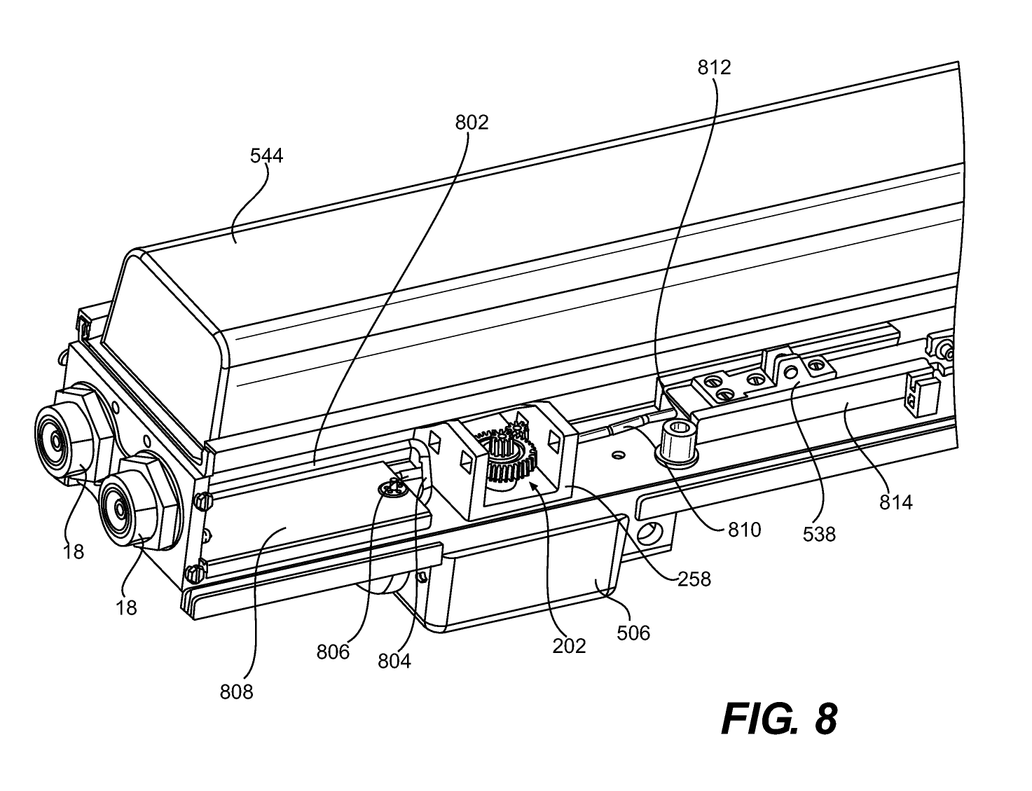

FIG. 8 shows a partial illustration of an antenna panel with a coaxial interface between components in accordance with another aspect of the instant invention. It should be noted that FIG. 8 does not illustrate all of the components for simplicity and such components are described above. In particular, FIG. 8 shows a configuration that may be implemented with features similar to those presented above, that may be implemented with a single row of radiators 20 (not shown), and adding a provision for dynamically altering power distribution and/or signal phasing from radiator 20 to radiator 20 or from group to group of radiators 20 under control from a local or remote location. One effect of such a change in electrical configuration may be to vary beam tilt; this may be exercised during initial setup of an antenna panel, in response to dynamic variations in operational requirements, etc.

The single-row crossed-dipole radiator panel embodiment of FIG. 8 shows two input connectors 18. The connector type may be suitable for such applications as cellular telephony up to 7.5 GHz with moderate power, should not be viewed as limiting. Beam tilt adjustment in the embodiment shown may use a motorized gear reducer 202 as described above. Other types of adjustment devices are contemplated as well. Each power divider may provide excitation to all of the radiators 20 in the array 10, but may only provide excitation to a respective one of the two dipoles 30, 32 in each radiator 20 (not shown in FIG. 8).

As further shown in FIG. 8, the input connectors 18 may connect to a coaxial cable 802. The coaxial cable 802 may be a PIM rated flexible cable. The coaxial cable 802 may extend from the input connectors 18 to a dielectric skid plate 814. The dielectric skid plate 814 may support the adapter 538. The coaxial cable 802 may bend at portion 804 and extend into a shield 808 as shown in FIG. 8. The coaxial cable 802 may loop within the shield 808 in such a manner to allow the skid plate 814 to move with respect to the connector 18 and still be connected to the coaxial cable 802. The coaxial cable 802 may extend from shield 808 and further extend through a hole in motorized gear reducer 202 as shown by portion 806 of the coaxial cable 802. The hole being sized to allow the coaxial cable 802 to easily slide therethrough.

The coaxial cable 802 may extend from the motorized gear reducer 202 with portion 810 of coaxial cable 802 to connect to the dielectric skid plate 814 at a connection point 812. The connection point 812 may include an outer portion of the coaxial cable 802 soldered to ground and an inner portion soldered to the strip line. Accordingly, the aspects of FIG. 8 provide a possibly lower cost alternative to the arrangements described above.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

We claim:

1. A radio-frequency signal power divider having variable phase, comprising:
a power divider enclosure;
a first microstrip segment that joins a feed connector at an attachment point, a longest dimension and a width dimension of the first segment being parallel to and proximal to a first inner surface of the enclosure;
an internal chamber formed within the first microstrip segment, open at an end distal to the feed connector, the open end including an edge proximal to the first enclosure inner surface;
a second microstrip segment inserted in part into the internal chamber, with a surface of the second microstrip segment proximal to the enclosure first inner surface and being in electrical contact with the edge, the second microstrip segment having an axis of insertion, to which axis slideable motion of the second microstrip segment over a range is constrained, conduction between the second microstrip segment and the edge being maintained;
a third microstrip segment, whereof a middle region is so configured with respect to a terminal face of the second microstrip segment as to form a slideable tee junction having such width that a terminal impedance of the second-segment equals the parallel combination of the third-segment impedances proximal to the tee, the third microstrip segment further being configured with two terminal ends; and
two load segments, each having a middle region configured to form a slideable tee junction with a third microstrip segment terminal end.

2. The variable-phase divider of claim 1, wherein the power divider enclosure is configured to be generally planar and conductive and comprises a first interior surface and the power divider enclosure further comprises:
a first conductive region elevated above a generally planar surface, extending from a locus immediately beyond an extent of the first segment to a locus on an order of a quarter wavelength distal thereto, with a height of elevation sufficient to establish an impedance over a first exposed portion of the second segment approximately equal to an impedance established by the first segment and a first surface of the internal chamber; and
at least one additional conductive region elevated above the generally planar surface, extending from a locus immediately beyond the extent of the first elevated conductive region to a locus on an order of a quarter wavelength distal thereto, with a height of elevation sufficient to establish an impedance over at least one additional exposed portion of the second segment having a value partway between that of a previous such region and an impedance characteristic of the second segment with respect to the first surface of the internal chamber.

3. The variable-phase divider of claim 1, wherein the power divider enclosure further comprises a plurality of orthogonal, planar inner surfaces.

4. The variable-phase divider of claim 1, wherein the first microstrip segment is joined to the feed connector by a controlled-impedance signal path.

5. The variable-phase divider of claim 1, wherein the second microstrip segment further comprises a terminal face so oriented as to permit motion of the second microstrip segment parallel to the axis of insertion.

6. The variable-phase divider of claim 1, wherein each of the two terminal ends further comprises a terminal face so oriented as to permit motion of the third microstrip segment parallel to the axis of insertion of the second segment.

7. The variable-phase divider of claim 1, wherein the second microstrip segment comprises a flat right-angle turn at a location between the inserted portion thereof and the terminal face thereof.

8. The variable-phase divider of claim 1, wherein a thickness dimension of the third segment is substantially the same as a thickness dimension of the second segment at a locus of proximity therebetween.

9. The variable-phase divider of claim 1, wherein the third microstrip segment comprises a flat right-angle turn generally proximal to each end of the third microstrip segment, at a location between a locus of proximity to the second segment and each terminal face of the third segment.

10. The variable-phase divider of claim 1, further comprising a linkage from an actuator assembly to the second segment and an actuator configured to direct motion of the second segment in line with the axis of insertion of the second segment.

11. The variable-phase divider of claim 1, wherein the third segment further comprises a uniform-width middle region thereof extending at least one quarter wavelength beyond a locus of proximity to a terminal face of the second segment.

12. The variable-phase divider of claim 1, wherein the third segment further comprises zero, one, or a plurality of step changes in impedance distal to a locus of proximity thereof to a terminal face of the second segment.

13. The variable-phase divider of claim 1, wherein the slideable tee junction between the third segment and the two load segments comprise substantially invariant impedance over a range of translation of the third segment.

14. The variable-phase divider of claim 1, further comprising a first dielectric shim located between respective proximal surfaces of the second and third segments and a second and a third dielectric shims located between respective proximal surfaces of the third segment and the load segments.

15. The variable-phase divider of claim 10, further comprising dielectric spacers that comprise a ceramic insulating material.

16. The variable-phase divider of claim 1, further comprising at least one insulating guide configured to permit and constrain relative motion of moving elements.

17. The variable-phase divider of claim 1, wherein a rate of motion of the second segment with reference to stationary components is different from a rate of motion of the third segment with reference thereto.

18. The variable-phase divider of claim 13, wherein the rate of motion of the second segment is three times as fast as a rate of motion of the third segment.

19. The variable-phase divider of claim 1, further comprising a motor configured to Intel motion of moving elements.

20. The variable-phase divider of claim 19, further comprising:
a first gear reducer, having an input shaft coupled directly or indirectly to the motor;
a second gear reducer, driven from an output of the first gear reducer;
a first pinion gear, driven from an output of the second gear reducer;
a second pinion gear, driven from an output of the second gear reducer;
a first rack, driven by the first pinion gear at a first rate;
a second rack, driven by the second pinion, directly or indirectly, at a second rate that is proportional to the first rate;
a first coupling linkage attaching the first rack to the second segment; and
a second coupling linkage attaching the second rack to the third segment.

21. The variable-phase divider of claim 20, wherein each of the first and second gear reducers further comprises a worm-and-wormgear reducer.

22. A method for varying the phase of an electromagnetic input signal applied to a plurality of radiators, the method comprising:
configuring a power divider with corporate feed in a form of a plurality of successive branchings of a signal path from an input port;
configuring at least one intermediate branching element of the power divider with a slideable input locus intermediate along a longitudinal extent thereof, and a slideable output locus at each of two distal ends thereof;
configuring an extensible element of the power divider with a fixed first segment and with a second segment that is conductively in contact with the first segment and occupies at least in part a void within the first segment;
establishing substantially constant impedance over a region proximal to a terminus of the first segment; and
providing a slideable coupling between a distal end of the second segment of the extensible element and the input locus of the intermediate branching element.

23. The method for varying the phase of an electromagnetic input signal applied to a plurality of radiators of claim 22, further comprising:
providing impedance alteration of the second segment of the extensible element with reference to a proximal ground plane, where the locus of the impedance alteration is spatially fixed independent of second segment position.

24. A radio-frequency signal power divider having variable phase, comprising:
means for dividing signal power from an input port into a plurality of successive corporate feed branchings;
means for configuring with a slideable input locus at least one intermediate branching element of the means for dividing signal power, and for configuring a slideable output locus at each of two distal ends thereof;
means for extending an element of the means for dividing signal power with a fixed first means for transporting signal power and a movable second means for transporting signal power that is conductively in contact with the first means for transporting signal power and occupies at least in part a void within the first means for transporting signal power; and
means for establishing substantially constant impedance over a region proximal to a terminus of the first means for transporting signal power.

25. The variable phase radio-frequency signal power divider of claim 24, further comprising means for establishing an input locus at an intermediate position along a longitudinal extent thereof.
